(19) United States
(12) Patent Application Publication
(10) Pub. No.: US 2026/0223096 A1
(43) Pub. Date: Jul. 30, 2026

(54) TECHNIQUES FOR BANDWIDTH PART SWITCHING

(71) Applicant: QUALCOMM Incorporated, San Diego, CA (US)

(72) Inventors: Hyun Yong LEE, San Diego, CA (US); Sitaramanjaneyulu KANAMARLAPUDI, San Diego, CA (US); Ozcan OZTURK, San Diego, CA (US); Linhai HE, San Diego, CA (US); Qing LI, Princeton Junction, NJ (US); Peerapol TINNAKORNSRISUPHAP, San Diego, CA (US); Mickael MONDET, Louannec (FR)

(21) Appl. No.: 19/038,525

(22) Filed: Jan. 27, 2025

(51) Int. Cl. H04W 72/0457; H04W 72/21; H04W 72/231; H04W 72/543

(52) U.S. Cl. CPC H04W 72/0457; H04W 72/21; H04W 72/231; H04W 72/543

(57) ABSTRACT

Various aspects of the present disclosure generally relate to wireless communication. In some aspects, a user equipment (UE) may receive control signaling indicating that UE-initiated bandwidth part switching is allowed. The UE may transmit, based at least in part on the UE-initiated bandwidth part switching being allowed, a request to switch a bandwidth part of the UE. The UE may switch from communicating via a first bandwidth part to communicating via a second bandwidth part based at least in part on the transmission of the request to switch the bandwidth part of the UE. Numerous other aspects are described.

### FIELD OF THE DISCLOSURE

Aspects of the present disclosure generally relate to wireless communication and specifically relate to techniques, apparatuses, and methods associated with techniques for bandwidth part switching.

### DESCRIPTION OF RELATED ART

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some wireless communication networks, a network node may configure a user equipment (UE) to communicate via a bandwidth part, which may correspond to part of a full channel bandwidth. Here, the UE may transmit and/or receive communications via a subset of the total channel bandwidth of the cell.

### SUMMARY

Some aspects described herein relate to a method of wireless communication performed by a user equipment (UE). The method may include receiving control signaling indicating that UE-initiated bandwidth part switching is allowed. The method may include transmitting, based at least in part on the UE-initiated bandwidth part switching being allowed, a request to switch a bandwidth part of the UE. The method may include switching from communicating via a first bandwidth part to communicating via a second bandwidth part based at least in part on the transmission of the request to switch the bandwidth part of the UE.

Some aspects described herein relate to a method of wireless communication performed by a UE. The method may include transmitting, to a network node, signaling indicating one or more parameters associated with an expected traffic pattern of communications at the UE. The method may include receiving, from the network node, a bandwidth part switching command indicating for the UE to switch from communicating via a first bandwidth part to communicating via a second bandwidth part.

Some aspects described herein relate to a method of wireless communication performed by a network node. The method may include receiving, from a UE, signaling indicating one or more parameters associated with an expected traffic pattern of communications at the UE. The method may include identifying a bandwidth part switch of the UE from communicating via a first bandwidth part to communicating via a second bandwidth part based at least in part on an output of an artificial intelligence or machine learning (AI/ML) model, where the one or more parameters associated with the expected traffic pattern are input to the AI/ML model. The method may include transmitting, to the UE, a bandwidth part switching command indicating for the UE to switch from communicating via the first bandwidth part to communicating via the second bandwidth part.

Some aspects described herein relate to a method of wireless communication performed by a network node. The method may include transmitting, to a UE, control signaling indicating that UE-initiated bandwidth part switching is allowed. The method may include receiving, from the UE and based at least in part on the UE-initiated bandwidth part switching being allowed, a request to switch a bandwidth part of the UE. The method may include switching from communicating with the UE via a first bandwidth part to communicating via a second bandwidth part based at least in part on the reception of the request to switch the bandwidth part of the UE.

Some aspects described herein relate to an apparatus for wireless communication at a UE. The apparatus may include one or more memories and one or more processors coupled to the one or more memories. The one or more processors may be configured to receive control signaling indicating that UE-initiated bandwidth part switching is allowed. The one or more processors may be configured to transmit, based at least in part on the UE-initiated bandwidth part switching being allowed, a request to switch a bandwidth part of the UE. The one or more processors may be configured to switch from communicating via a first bandwidth part to communicating via a second bandwidth part based at least in part on the transmission of the request to switch the bandwidth part of the UE.

Some aspects described herein relate to an apparatus for wireless communication at a UE. The apparatus may include one or more memories and one or more processors coupled to the one or more memories. The one or more processors may be configured to transmit, to a network node, signaling indicating one or more parameters associated with an expected traffic pattern of communications at the UE. The one or more processors may be configured to receive, from the network node, a bandwidth part switching command indicating for the UE to switch from communicating via a first bandwidth part to communicating via a second bandwidth part.

Some aspects described herein relate to an apparatus for wireless communication at a network node. The apparatus may include one or more memories and one or more processors coupled to the one or more memories. The one or more processors may be configured to receive, from a UE, signaling indicating one or more parameters associated with an expected traffic pattern of communications at the UE. The one or more processors may be configured to identify a bandwidth part switch of the UE from communicating via a first bandwidth part to communicating via a second bandwidth part based at least in part on an output of an AI/ML model, where the one or more parameters associated with the expected traffic pattern are input to the AI/ML model. The one or more processors may be configured to transmit, to the UE, a bandwidth part switching command indicating for the UE to switch from communicating via the first bandwidth part to communicating via the second bandwidth part.

Some aspects described herein relate to an apparatus for wireless communication at a network node. The apparatus may include one or more memories and one or more processors coupled to the one or more memories. The one or more processors may be configured to transmit, to a UE, control signaling indicating that UE-initiated bandwidth part switching is allowed. The one or more processors may be configured to receive, from the UE and based at least in part on the UE-initiated bandwidth part switching being allowed, a request to switch a bandwidth part of the UE. The one or more processors may be configured to switch from communicating with the UE via a first bandwidth part to communicating via a second bandwidth part based at least in part on the reception of the request to switch the bandwidth part of the UE.

Some aspects described herein relate to a non-transitory computer-readable medium that stores a set of instructions for wireless communication by a UE. The set of instructions, when executed by one or more processors of the UE, may cause the UE to receive control signaling indicating that UE-initiated bandwidth part switching is allowed. The set of instructions, when executed by one or more processors of the UE, may cause the UE to transmit, based at least in part on the UE-initiated bandwidth part switching being allowed, a request to switch a bandwidth part of the UE. The set of instructions, when executed by one or more processors of the UE, may cause the UE to switch from communicating via a first bandwidth part to communicating via a second bandwidth part based at least in part on the transmission of the request to switch the bandwidth part of the UE.

Some aspects described herein relate to a non-transitory computer-readable medium that stores a set of instructions for wireless communication by a UE. The set of instructions, when executed by one or more processors of the UE, may cause the UE to transmit, to a network node, signaling indicating one or more parameters associated with an expected traffic pattern of communications at the UE. The set of instructions, when executed by one or more processors of the UE, may cause the UE to receive, from the network node, a bandwidth part switching command indicating for the UE to switch from communicating via a first bandwidth part to communicating via a second bandwidth part.

Some aspects described herein relate to a non-transitory computer-readable medium that stores a set of instructions for wireless communication by a network node. The set of instructions, when executed by one or more processors of the network node, may cause the network node to receive, from a UE, signaling indicating one or more parameters associated with an expected traffic pattern of communications at the UE. The set of instructions, when executed by one or more processors of the network node, may cause the network node to identify a bandwidth part switch of the UE from communicating via a first bandwidth part to communicating via a second bandwidth part based at least in part on an output of an AI/ML model, where the one or more parameters associated with the expected traffic pattern are input to the AI/ML model. The set of instructions, when executed by one or more processors of the network node, may cause the network node to transmit, to the UE, a bandwidth part switching command indicating for the UE to switch from communicating via the first bandwidth part to communicating via the second bandwidth part.

Some aspects described herein relate to a non-transitory computer-readable medium that stores a set of instructions for wireless communication by a network node. The set of instructions, when executed by one or more processors of the network node, may cause the network node to transmit, to a UE, control signaling indicating that UE-initiated bandwidth part switching is allowed. The set of instructions, when executed by one or more processors of the network node, may cause the network node to receive, from the UE and based at least in part on the UE-initiated bandwidth part switching being allowed, a request to switch a bandwidth part of the UE. The set of instructions, when executed by one or more processors of the network node, may cause the network node to switch from communicating with the UE via a first bandwidth part to communicating via a second bandwidth part based at least in part on the reception of the request to switch the bandwidth part of the UE.

Some aspects described herein relate to an apparatus for wireless communication. The apparatus may include means for receiving control signaling indicating that UE-initiated bandwidth part switching is allowed. The apparatus may include means for transmitting, based at least in part on the UE-initiated bandwidth part switching being allowed, a request to switch a bandwidth part of the apparatus. The apparatus may include means for switching from communicating via a first bandwidth part to communicating via a second bandwidth part based at least in part on the transmission of the request to switch the bandwidth part of the apparatus.

Some aspects described herein relate to an apparatus for wireless communication. The apparatus may include means for transmitting, to a network node, signaling indicating one or more parameters associated with an expected traffic pattern of communications at the apparatus. The apparatus may include means for receiving, from the network node, a bandwidth part switching command indicating for the apparatus to switch from communicating via a first bandwidth part to communicating via a second bandwidth part.

Some aspects described herein relate to an apparatus for wireless communication. The apparatus may include means for receiving, from a UE, signaling indicating one or more parameters associated with an expected traffic pattern of communications at the UE. The apparatus may include means for identifying a bandwidth part switch of the UE from communicating via a first bandwidth part to communicating via a second bandwidth part based at least in part on an output of an AI/ML model, where the one or more parameters associated with the expected traffic pattern are input to the AI/ML model. The apparatus may include means for transmitting, to the UE, a bandwidth part switching command indicating for the UE to switch from communicating via the first bandwidth part to communicating via the second bandwidth part.

Some aspects described herein relate to an apparatus for wireless communication. The apparatus may include means for transmitting, to a UE, control signaling indicating that UE-initiated bandwidth part switching is allowed. The apparatus may include means for receiving, from the UE and based at least in part on the UE-initiated bandwidth part switching being allowed, a request to switch a bandwidth part of the UE. The apparatus may include means for switching from communicating with the UE via a first bandwidth part to communicating via a second bandwidth part based at least in part on the reception of the request to switch the bandwidth part of the UE.

Aspects of the present disclosure may generally be implemented by or as a method, apparatus, system, computer program product, non-transitory computer-readable medium, UE, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3 and 4 are diagrams illustrating example bandwidth part switching of a UE, in accordance with the present disclosure.

FIG. 5 is a diagram illustrating an example of a UE-initiated bandwidth part switching, in accordance with the present disclosure.

FIG. 6 is a diagram illustrating an example of a network-node-initiated bandwidth part switching, in accordance with the present disclosure.

FIGS. 7 and 8 are diagrams illustrating example processes performed, for example, at a UE or an apparatus of a UE, in accordance with the present disclosure.

FIGS. 9 and 10 are diagrams illustrating example processes performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, a network node may configure a user equipment (UE) to communicate via a bandwidth part, which may correspond to part of a full channel bandwidth. Here, the UE may transmit and/or receive communications via a subset of the total channel bandwidth of the cell. The network node may identify the bandwidth part for communications at the UE based on the expected volume and characteristics of traffic at the UE. For example, if the network node determines that the expected traffic at the UE is associated with a low data rate, is not delay sensitive, and/or is sparse, the network node may configure the UE to communicate via a narrow bandwidth part. Additionally, if the network node determines that the expected traffic at the UE is associated with a high data rate, is delay sensitive, and/or includes bursty traffic, the network node may configure the UE to communicate via a large (e.g., a wider) bandwidth part. Accordingly, the network node may initiate a bandwidth part switch of the UE based on the volume and characteristics of the traffic expected by the network node at the UE.

However, the network node may not be able to accurately predict the volume and characteristics of the traffic at the UE. That is, the network node may be unaware of a user-specific traffic pattern at the UE, of which application or applications are running at the UE, and of whether the traffic associated with the application or applications is latency-sensitive. Accordingly, the network node may not be able to accurately predict whether the expected traffic at the UE will be associated with a low data rate or a high data rate, whether the data will or will not be delay sensitive, or whether the data will be relatively sparse or bursty. As a result, the network node may configure the UE with a bandwidth part that is too large (e.g., which may cause the UE to consume more power than necessary) or that is too small (e.g., which may introduce latency into communications at the UE).

Various aspects relate generally to bandwidth part switching of a UE from a first bandwidth part to a second bandwidth part, where the second bandwidth part is identified based on additional information related to the expected traffic at the UE. That is, the UE or a network node may identify the second bandwidth part based on one or more applications being executed by the UE, one or more application buffer statuses at the UE, a timing of expected traffic arriving at the UE, a volume of the expected traffic, and/or a priority of the expected traffic. In some cases, the UE or the network node may identify the second bandwidth part based on executing an artificial intelligence or machine learning (AI/ML) model. That is, the UE or the network node may input the additional information into the AI/ML model, and the AI/ML model may output an indication of the second bandwidth part for the UE-initiated bandwidth part switching.

In one example, the bandwidth part switching of the UE may be a UE-initiated bandwidth part switching (e.g., as opposed to a network-node-initiated bandwidth part switching). That is, the network node may transmit control signaling indicating to the UE that UE-initiated bandwidth part switching is allowed, and the UE may then identify the second bandwidth part for the bandwidth part switching. Based on identifying the second bandwidth part, the UE may transmit a request to the network node to switch the bandwidth part of the UE. In some cases, the network node may indicate for the UE to perform UE-initiated bandwidth part switching autonomously and without receiving a confirmation from the network node to perform the bandwidth part switching of the UE. In some other cases, the network node may instead transmit a confirmation message in response to the request from the UE, and the UE may switch to communicating via the second bandwidth part based on receiving the confirmation message from the network node.

In another example, the bandwidth part switching of the UE may be a network-node-initiated bandwidth part switching that is based on the additional information related to the expected traffic at the UE. That is, the UE may transmit assistance information to the network node that indicates the additional information. Then, the network node may identify the second bandwidth part for the bandwidth part switching of the UE based on the assistance information and may transmit a bandwidth part switching command indicating for the UE to switch to the second bandwidth part. In some cases, the network node may identify the second bandwidth part based on executing an AI/ML model.

Particular aspects of the subject matter described in this disclosure can be implemented to realize one or more of the following potential advantages. In some examples, the described techniques can be used to improve the performance of the UE by bandwidth part switching. That is, by using additional information (such as the applications being executed by the UE, buffer status at the UE, the timing or priority of the expected traffic at the UE) to identify the bandwidth part for the bandwidth part switching of the UE, the UE may switch to a bandwidth part that is more suitable for the communications at the UE. That is, the additional information may improve a likelihood that the UE is communicating via a narrow bandwidth part when the UE is communicating traffic with a low data rate, that is not delay-sensitive, or that is sparse, thereby improving a power consumption of the UE (e.g., as compared to when the UE is communicating via a larger bandwidth part) without introducing latency into the communications at the UE. Additionally, the additional information may improve a likelihood that the UE is communicating via a large bandwidth part when the UE is communicating traffic with a high data rate, that is delay-sensitive, or that is bursty, which may in turn improve a latency associated with communications at the UE. Therefore, particular aspects of the subject matter described in this disclosure can be implemented to decrease a power consumption of the UE and decrease a latency associated with communications at the UE.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or AI/ML, among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

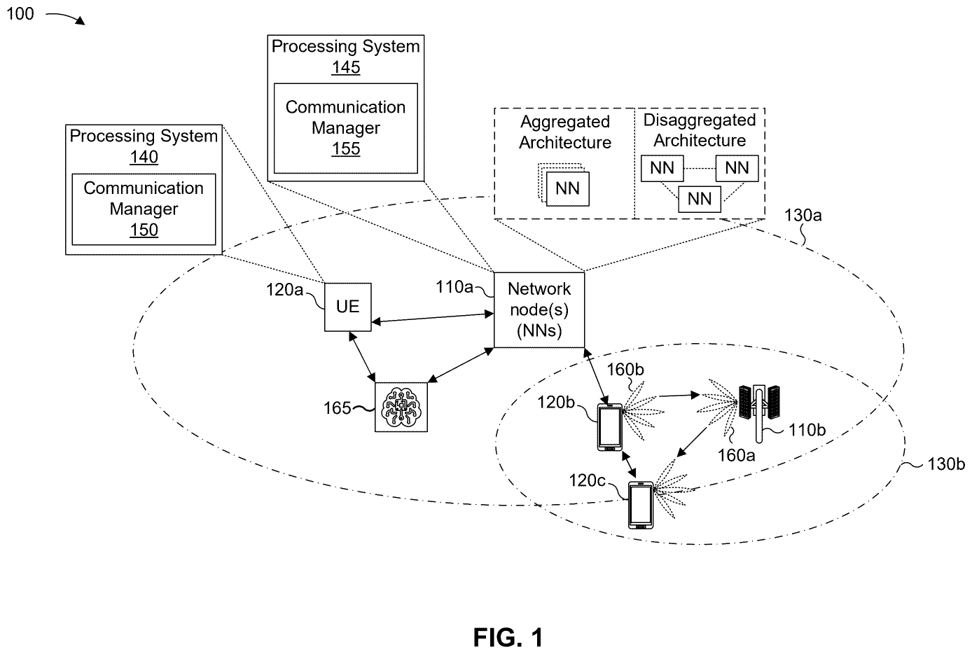

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A processing system (e.g., the processing system 140 and/or the processing system 145) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120. The processing system 140 of the network node 110 may be a system that includes the various other components or subcomponents of the network node 110.

The processing system 145 of the network node 110 may interface with one or more other components of the network node 110, may process information received from one or more other components (such as inputs or signals), or may output information to one or more other components. For example, a chip or modem of the network node 110 may include the processing system 145, a first interface to receive or obtain information, and a second interface to output, transmit, or provide information. In some examples, the first interface may be an interface between the processing system 145 of the chip or modem and a receiver, such that the network node 110 may receive information or signal inputs, and the information may be passed to the processing system 145. In some examples, the second interface may be an interface between the processing system 145 of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also may output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

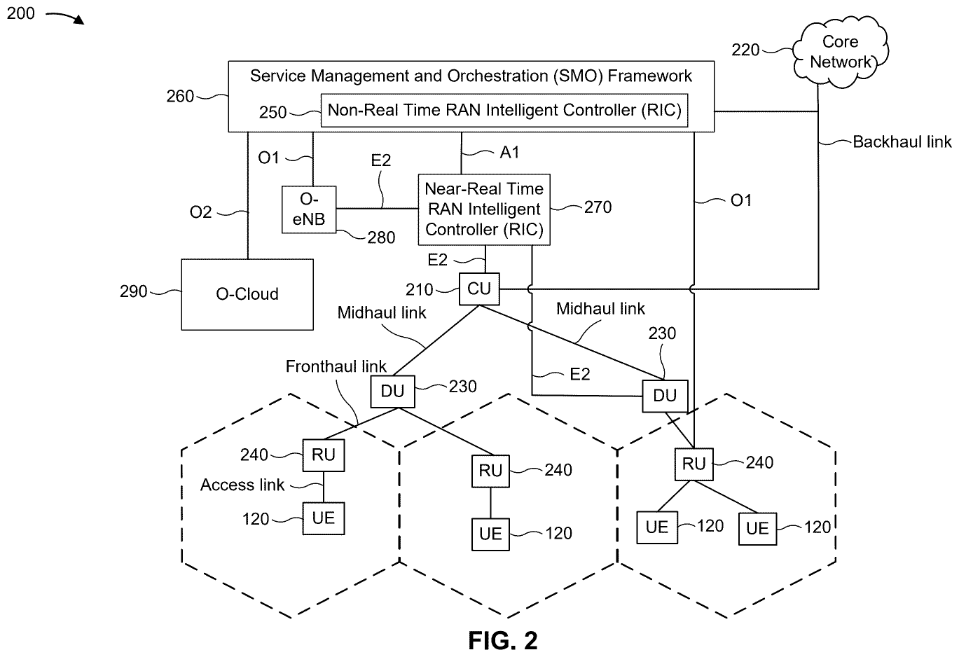

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts. A bandwidth part may be a block of frequency domain resources (for example, a continuous set of resource blocks (RBs) within a full component carrier bandwidth) that may be configured at a UE-specific level. A UE 120 may be configured with both an uplink bandwidth part and a downlink bandwidth part (which may be the same or different). Each bandwidth part may be associated with its own numerology (indicating a sub-carrier spacing (SCS) and cyclic prefix (CP)). A bandwidth part may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active bandwidth part defines the operating bandwidth of the UE 120 within the operating bandwidth of the serving cell. That is, the active bandwidth part corresponds to the operating bandwidth of the UE 120 at a specific moment of operation. The use of bandwidth parts enables more efficient use of the available frequency domain resources in the wireless communication network 100 because fewer frequency domain resources may be allocated to a bandwidth part for a UE 120, leaving more frequency domain resources to be spread across multiple UEs 120. The allocation of fewer frequency domain resources to a UE may reduce the number of frequency domain resources that a UE 120 is required to monitor (such as control resource set resources for physical downlink control channel (PDCCH) monitoring) and reduce UE power consumption by enabling the UE to monitor fewer frequency domain resources. Additionally, the allocation of fewer frequency resources to a UE may reduce a buffering of physical downlink shared channel (PDSCH) symbols until the DCI is decoded. Thus, bandwidth parts may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

As indicated above, a bandwidth part may be configured as a subset or a part of a total or full component carrier bandwidth and generally forms or encompasses a set of contiguous common resource blocks (CRBs) within the full component carrier bandwidth. In other words, within the carrier bandwidth, a bandwidth part starts at a CRB and may span a set of consecutive CRBs. Each bandwidth part may be associated with its own numerology (indicating an SCS and CP). A UE 120 may be configured with up to four downlink bandwidth parts and up to four uplink bandwidth parts for each serving cell. To enable reasonable UE battery consumption, only one bandwidth part in the downlink and one bandwidth part in the uplink are generally active at a given time on an active serving cell under typical operation. The active bandwidth part defines the operating bandwidth of the UE 120 within the operating bandwidth of the serving cell while all other bandwidth parts with which the UE 120 is configured are deactivated. On deactivated bandwidth parts, the UE 120 does not transmit or receive any communications.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) number of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi-co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may receive control signaling indicating that UE-initiated bandwidth part switching is allowed; transmit, based at least in part on the UE-initiated bandwidth part switching being allowed, a request to switch a bandwidth part of the UE; and switch from communicating via a first bandwidth part to communicating via a second bandwidth part based at least in part on the transmission of the request to switch the bandwidth part of the UE. Additionally, or alternatively, and as described in more detail elsewhere herein, the communication manager 150 may transmit, to a network node, signaling indicating one or more parameters associated with an expected traffic pattern of communications at the UE; and receive, from the network node, a bandwidth part switching command indicating for the UE to switch from communicating via a first bandwidth part to communicating via a second bandwidth part. Additionally, or alternatively, the communication manager 150 may perform one or more other operations described herein.

In some aspects, the network node 110 may include a communication manager 155. As described in more detail elsewhere herein, the communication manager 155 may receive, from a UE, signaling indicating one or more parameters associated with an expected traffic pattern of communications at the UE; identify a bandwidth part switch of the UE from communicating via a first bandwidth part to communicating via a second bandwidth part based at least in part on an output of an AI/ML model, wherein the one or more parameters associated with the expected traffic pattern are input to the AI/ML model; and transmit, to the UE, a bandwidth part switching command indicating for the UE to switch from communicating via the first bandwidth part to communicating via the second bandwidth part. Additionally, or alternatively, and as described in more detail elsewhere herein, the communication manager 155 may transmit, to a UE, control signaling indicating that UE-initiated bandwidth part switching is allowed; receive, from the UE and based at least in part on the UE-initiated bandwidth part switching being allowed, a request to switch a bandwidth part of the UE; and switch from communicating with the UE via a first bandwidth part to communicating via a second bandwidth part based at least in part on the reception of the request to switch the bandwidth part of the UE. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more

PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

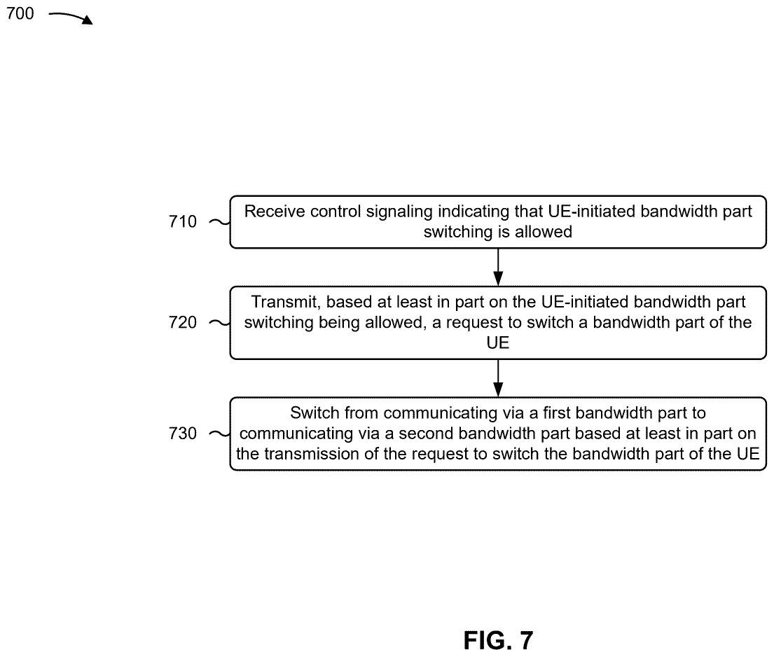

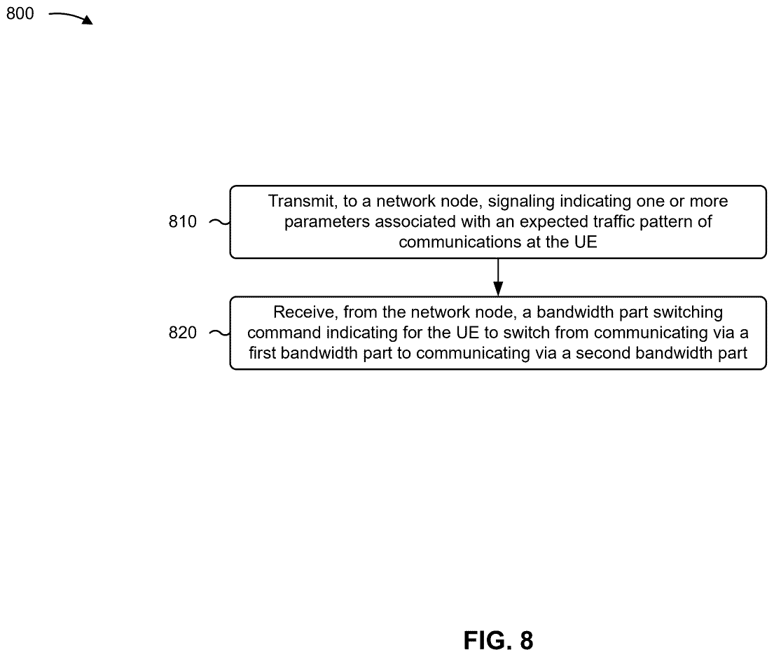

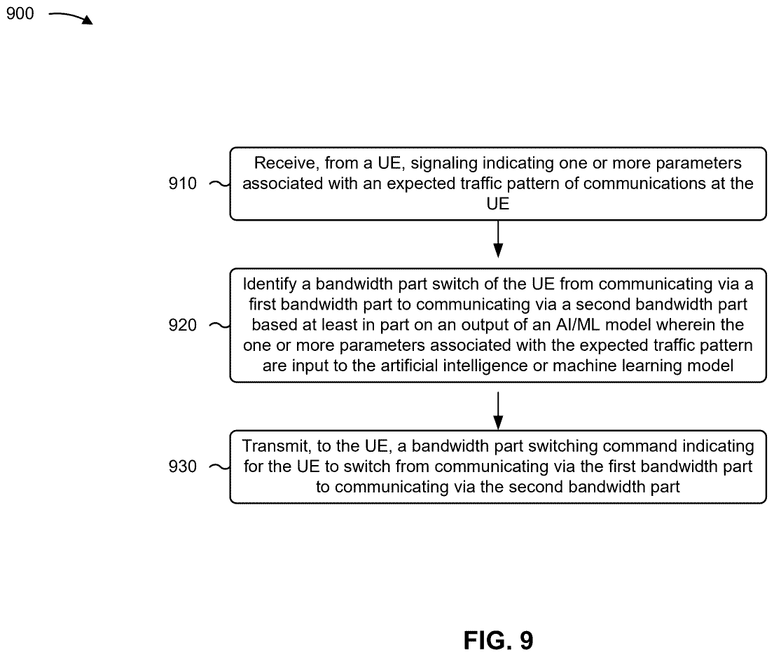

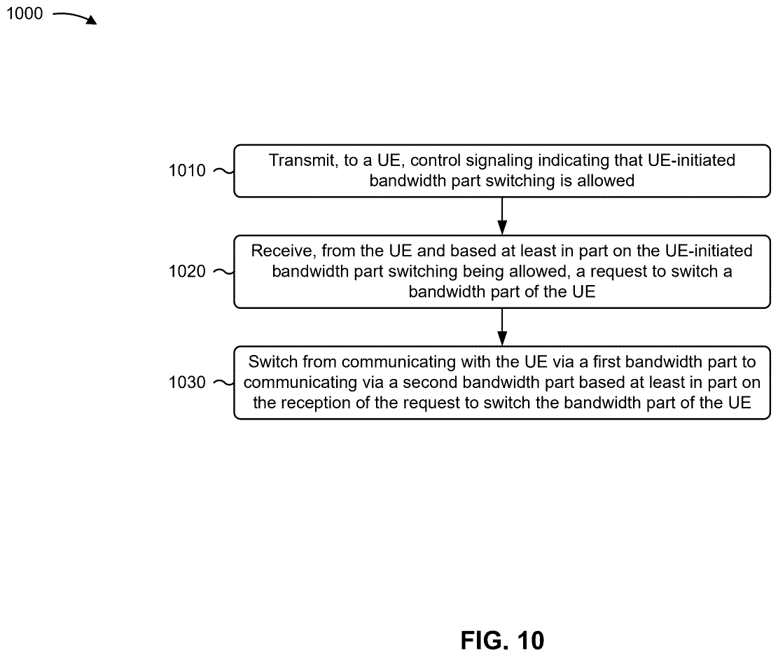

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with techniques for bandwidth part switching, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, process 900 of FIG. 9, process 1000 of FIG. 10, or other processes as described herein. In some examples, executing instructions may include running the instructions, converting the instructions, compiling the instructions, and/or interpreting the instructions, among other examples.

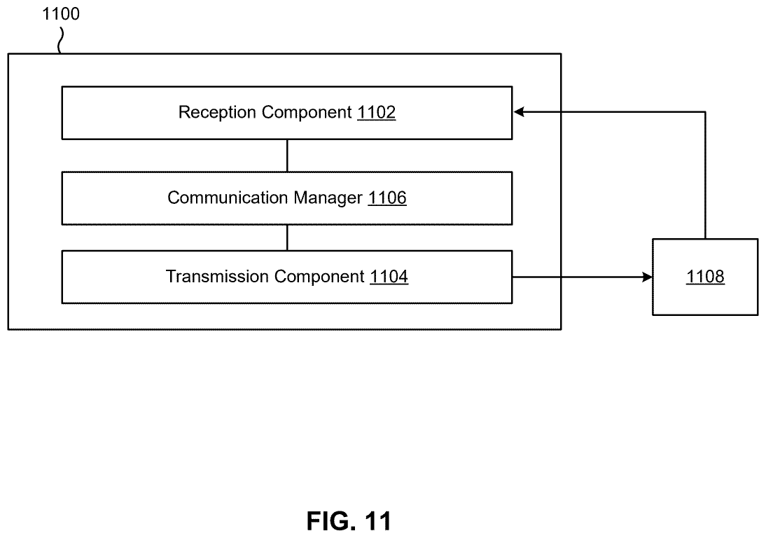

In some aspects, a UE includes means for receiving control signaling indicating that UE-initiated bandwidth part switching is allowed; means for transmitting, based at least in part on the UE-initiated bandwidth part switching being allowed, a request to switch a bandwidth part of the UE; and/or means for switching from communicating via a first bandwidth part to communicating via a second bandwidth part based at least in part on the transmission of the request to switch the bandwidth part of the UE. In some other aspects, a UE includes means for transmitting, to a network node, signaling indicating one or more parameters associated with an expected traffic pattern of communications at the UE; and/or means for receiving, from the network node, a bandwidth part switching command indicating for the UE to switch from communicating via a first bandwidth part to communicating via a second bandwidth part. The means for the UE to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

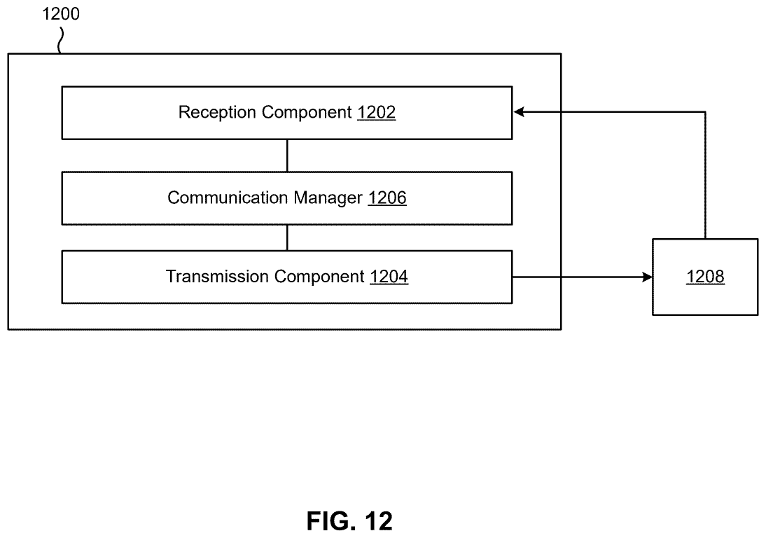

In some aspects, a network node includes means for receiving, from a UE, signaling indicating one or more parameters associated with an expected traffic pattern of communications at the UE; means for identifying a bandwidth part switch of the UE from communicating via a first bandwidth part to communicating via a second bandwidth part based at least in part on an output of an AI/ML model, wherein the one or more parameters associated with the expected traffic pattern are input to the AI/ML model; and/or means for transmitting, to the UE, a bandwidth part switching command indicating for the UE to switch from communicating via the first bandwidth part to communicating via the second bandwidth part. In some other aspects, a network node includes means for transmitting, to a UE, control signaling indicating that UE-initiated bandwidth part switching is allowed; means for receiving, from the UE and based at least in part on the UE-initiated bandwidth part switching being allowed, a request to switch a bandwidth part of the UE; and/or means for switching from communicating with the UE via a first bandwidth part to communicating via a second bandwidth part based at least in part on the reception of the request to switch the bandwidth part of the UE. The means for the network node to perform operations described herein May include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

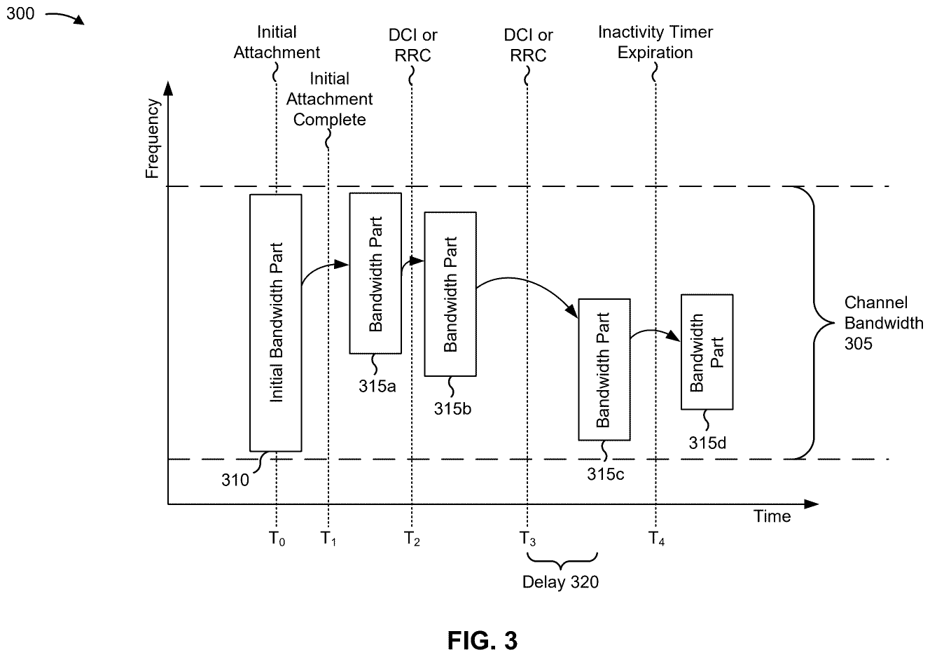

FIG. 3 is a diagram illustrating an example 300 illustrating bandwidth part switching of a UE, in accordance with the present disclosure. The example 300 illustrates bandwidth part switching that is initiated by the network node.

The example 300 illustrates an initial bandwidth part 310 used for communications between a UE and a network node, and four other bandwidth parts 315 used for subsequent communications between the UE and the network node. The network node may initiate or configure the bandwidth part switching of the UE from the initial bandwidth part 310 to the bandwidth part 315a, from the bandwidth part 315a to the bandwidth part 315b, from the bandwidth part 315b to the bandwidth part 315c, and from the bandwidth part 315c to the bandwidth part 315d.

At time To, a UE may perform an initial attachment to establish a connection with a network node. The UE may establish the initial connection with the network node (e.g., as part of the initial attachment) via the initial bandwidth part 310. In some cases, the UE may perform the initial attachment via an initial bandwidth part 310 that spans most of or all of the channel bandwidth 305. At time T1, the initial attachment of the UE with the network node may be complete.

After the UE establishes a connection with the network node via the initial bandwidth part 310, the network node may explicitly indicate, to the UE, for the UE to use the bandwidth part 315a for communications at the UE. For example, as part of the initial configuration, the network node may indicate that the bandwidth part 315a is the first active bandwidth part of the UE (e.g., via RRC signaling). In some cases, the network node may configure the UE to communicate via a first active bandwidth part (e.g., the bandwidth part 315a) that spans fewer frequency resources of the channel bandwidth 305 as compared to the initial bandwidth part 310. Additionally, the network node may indicate for the UE to use a bandwidth part 315 by transmitting a bandwidth part switching command to the UE via DCI (e.g., via DCI Format 0_1 signaling, via DCI Format 1_1 signaling) or via RRC signaling. For example, at times T2 and T3, the network node may transmit a bandwidth part switching command to the UE indicating for the UE to switch to the bandwidth parts 315b and 315c, respectively. Additionally, or alternatively, the network node may explicitly indicate a bandwidth part 315 for communications at the UE within a configuration of an inactivity timer (e.g., a bwp-inactivity timer). For example, the network node may configure the bandwidth part 315d as a default bandwidth part and may indicate for the UE to switch to the default bandwidth part upon an expiration of the inactivity timer. In the example 300, the UE may switch from the bandwidth part 315c to the bandwidth part 315d based on starting the inactivity timer at time T4 (e.g., in response to detecting inactivity) and the inactivity timer expiring.

Some network-node-initiated bandwidth part switching may be associated with a delay 320, which may be up to three milliseconds. In some examples, the delay 320 may correspond to a sum of an optional serving cell switching delay (Y) and a bandwidth part switch delay (T). Here, the serving cell switching delay Y may not exist (e.g., may be zero slots) if the serving cell where the UE receives the DCI or RRC indicating the bandwidth part switching command is the same as the serving cell on which the bandwidth part switch occurs. Additionally, the serving cell switching delay Y may be one slot if the serving cell where the UE receives the DCI or RRC indicating the bandwidth part switching command is different from the serving cell on which the bandwidth part switch occurs for any involved serving cell. The bandwidth part switch delay T may be defined based on a capability of the UE and the SCS associated with the bandwidth part. Table 1, shown below, illustrates an example definition of the bandwidth part switch delay. In the example illustrated by Table 1, μ may be based on an SCS associated with the bandwidth part (e.g., where the SCS=15 kHz×2^{μ}).

TABLE 1
Bandwidth Part Switch Delay

| | Slot Length | Bandwidth Part Switch Delay T (slots) | |
|---|---|---|---|
| μ | (milliseconds) | UE Capability Type 1 | UE Capability Type 2 |
| 0 | 1 | 1 | 3 |
| 1 | 0.5 | 2 | 5 |
| 2 | 0.25 | 3 | 9 |
| 3 | 0.125 | 6 | 18 |

The network node may identify the bandwidth part for the bandwidth part switching of the UE based on one or more parameters associated with communications at the UE. That is, the network node may rely on the one or more parameters associated with the communications at the UE to attempt to predict the volume and characteristics of the traffic at the UE. For example, the network node may identify the bandwidth part based on quality of service requirements associated with communications at the UE, a downlink buffer status associated with communications at the UE, an uplink buffer status report received from the UE, and/or a traffic arrival pattern of periodic traffic received from the UE (e.g., XR communications). In some cases, the network node may determine the traffic arrival pattern of the periodic traffic received from the UE based on time-sensitive communication assistance information (TSCAI) associated with the periodic traffic, a time-sensitive communication assistance container (TSCAC) associated with the periodic traffic, and/or uplink assistance information (UAI) received from the UE.

The network node may identify the bandwidth part for the bandwidth part switching of the UE based on the predicted volume and characteristics of the traffic at the UE. For example, if the network node determines that the expected traffic at the UE is associated with a low data rate, is not delay sensitive, and/or is sparse, the network node may configure the UE to communicate via a narrow bandwidth part 315. Additionally, if the network node determines that the expected traffic at the UE is associated with a high data rate, is delay sensitive, and/or includes bursty traffic, the network node may configure the UE to communicate via a large (e.g., a wider) bandwidth part 315. Accordingly, the network node may initiate a bandwidth part switch of the UE based on the volume and characteristics of the traffic expected by the network node at the UE.

However, the network node may not be able to accurately predict the volume and characteristics of the traffic at the UE. That is, the network node may be unaware of a user-specific traffic pattern at the UE, of which application or applications are running at the UE, and of whether the traffic associated with the application or applications is latency sensitive. Accordingly, the network node may not be able to accurately predict whether the expected traffic at the UE will be associated with a low data rate or a high data rate, whether the data will or will not be delay sensitive, or whether the data will be relatively sparse or bursty. As a result, the network node may configure the UE with a bandwidth part that is too large (e.g., which may cause the UE to consume more power than necessary) or that is too small (e.g., which may introduce latency into communications at the UE).

While the network node may, in some cases, rely on an uplink buffer status report from the UE to identify a bandwidth part for bandwidth part switching (which may allow the network node to more accurately predict the volume of the traffic at the UE), bandwidth part switching based on the uplink buffer status report may be relatively slow. That is, there may be a delay between the UE transmitting the uplink buffer status report and the network node identifying a bandwidth part for a bandwidth part switch of the UE based on the uplink buffer status report. For example, there may be a three-millisecond delay between the UE transmitting the uplink buffer status report and the network node transmitting a bandwidth part switching command based on the uplink buffer status report.

Additionally, the network node may not be aware of a UE-specific implementation associated with a power saving at the UE when identifying a bandwidth part for a bandwidth part switching of the UE. That is, the network node may not be aware of a power saving effect of switching the UE to different bandwidth parts, which may decrease a power savings associated with network-node-initiated bandwidth part switching (e.g., based on the network node being unaware of the UE power savings associated with different bandwidth parts).

Various aspects in the present disclosure relate generally to bandwidth part switching of the UE from a first bandwidth part to a second bandwidth part, where the second bandwidth part is identified based on additional information related to the expected traffic at the UE. That is, the UE or the network node may identify the second bandwidth part based on one or more applications being executed by the UE, one or more application buffer statuses at the UE, a timing of expected traffic arriving at the UE, a volume of the expected traffic, and/or a priority of the expected traffic. In some cases, the UE or the network node may identify the second bandwidth part based on executing an AI/ML model. That is, the UE or the network node may input the additional information into the AI/ML model, and the AI/ML model may output an indication of the second bandwidth part for the UE-initiated bandwidth part switching.

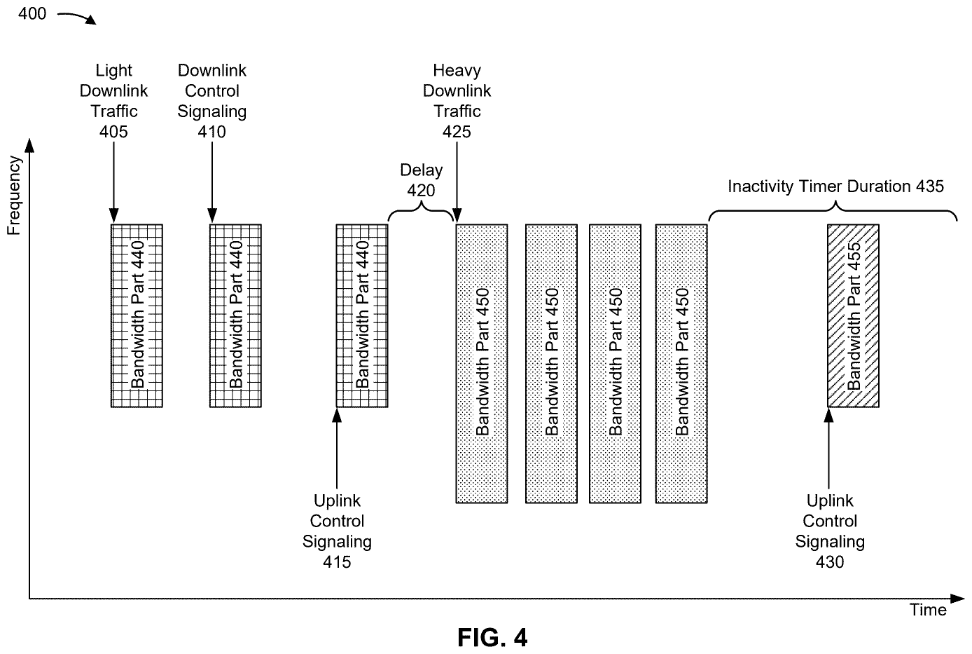

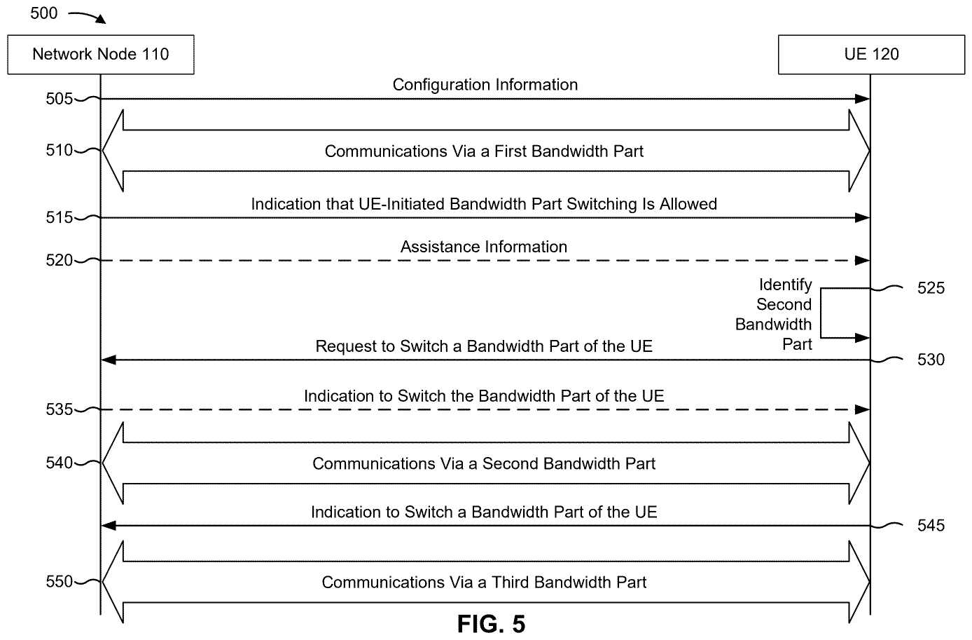

In one example, the bandwidth part switching of the UE may be a UE-initiated bandwidth part switching (e.g., as opposed to a network-node-initiated bandwidth part switching). For UE-initiated bandwidth part switching, the network node may indicate that UE-initiated bandwidth part switching is allowed, and the UE may identify the second bandwidth part for the bandwidth part switching. Then the UE may transmit a request to the network node to switch the bandwidth part of the UE. FIGS. 4 and 5 describe features related to the UE-initiated bandwidth part switching.

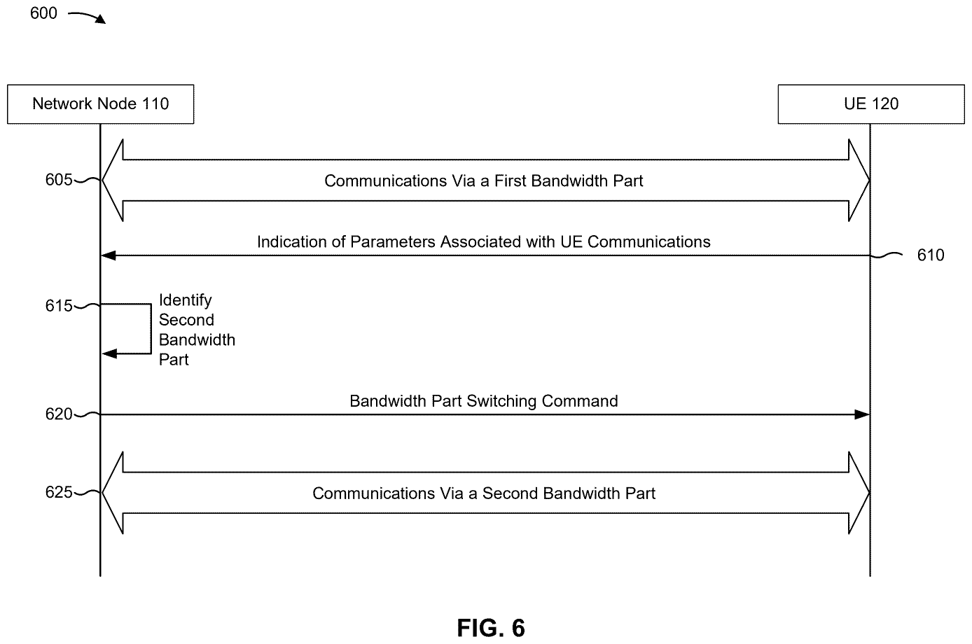

In another example, the bandwidth part switching of the UE may be a network-node-initiated bandwidth part switching that is based on the additional information related to the expected traffic at the UE. That is, the UE may transmit assistance information to the network node that indicates the additional information. Then, the network node may identify the second bandwidth part for the bandwidth part switching of the UE based on the assistance information and may transmit a bandwidth part switching command indicating for the UE to switch to the second bandwidth part. In some cases, the network node may identify the second bandwidth part based on executing an AI/ML model. FIG. 6 describes features related to the network-node-initiated bandwidth part switching that is based on the additional information related to the expected traffic at the UE.

As indicated above, FIG. 3 is provided as an example. Other examples may differ from what is described with respect to FIG. 3.

FIG. 4 is a diagram illustrating an example 400 illustrating bandwidth part switching of a UE, in accordance with the present disclosure. The example 400 illustrates bandwidth part switching that is initiated by a UE. For example, the UE switching from the bandwidth part 440 to the bandwidth part 450 may be based on the UE initiating the bandwidth part switch.

The network node may configure the UE to communicate via the bandwidth part 440. For example, the network node may transmit control signaling (e.g., RRC signaling) indicating a bandwidth part configuration of the UE and configuring the UE to communicate via the bandwidth part 440. Accordingly, the UE may communicate via the bandwidth part 440. For example, the network node may transmit, and the UE may receive, light downlink traffic 405 via the bandwidth part 440. In some cases, “light downlink traffic” may refer to downlink traffic that is associated with a relatively low data rate or downlink traffic that is sparse.

Additionally, the UE may receive the downlink control signaling 410 via the bandwidth part 440. The downlink control signaling 410 may include an indication of whether UE-initiated bandwidth part switching is allowed. The network node may indicate whether the UE-initiated bandwidth part switching is allowed semi-statically (e.g., by transmitting the downlink control signaling 410 via RRC signaling), semi-persistently (e.g., by transmitting the downlink control signaling via a MAC-CE), or dynamically (e.g., by transmitting the downlink control signaling via DCI). If the network node indicates via DCI whether the bandwidth part switching is allowed, the DCI may include a bandwidth part identifier that is indicative of whether the UE-initiated bandwidth part switching is allowed (e.g., a first bandwidth part identifier is indicative of UE-initiated bandwidth part switching being allowed and a second bandwidth part identifier is indicative of UE-initiated bandwidth part switching not being allowed). In the example 400, the downlink control signaling 410 may include an indication that the UE-initiated bandwidth part switching is allowed.

A UE may be aware of additional information (e.g., as compared to a network node) that enables the UE to more accurately determine an expected traffic pattern associated with communications at the UE, which may in turn enable the UE to identify a bandwidth part for the bandwidth part switch of the UE that better suits the communications at the UE (e.g., as compared to a network node identifying the bandwidth part). The additional information may be associated with a timing of expected traffic arriving at the UE, a volume of the expected traffic, and/or a priority of the expected traffic.

In some cases, the additional information may also include an application being executed by the UE, whether the application corresponds to a front-running application or an application being executed in the background, and/or information related to a user of the UE. For example, the UE may determine the expected traffic pattern based on an application being executed by the UE. That is, the UE may identify the expected traffic pattern associated with communications at the UE based on a video buffer status associated with an application being executed by the UE or a data consumption pattern of an application being executed by the UE (e.g., which may be different based on a type of the application, such as whether the application is a gaming application, a video application, or a web-browsing application). In another example, the UE may determine the expected traffic pattern based on a front running application being executed by the UE to predict the volume and characteristics of the traffic at the UE. That is, the UE may rely on information such as a front running application at the UE (e.g., and a latency associated with traffic for that application), a pattern of application use by the user, or other user or application-specific information.

In one case, the UE may determine that the expected traffic pattern is associated with an increase in the volume of the traffic based on a user of the UE switching a front running application of the UE to an application that is associated with heavy downlink traffic or delay-sensitive traffic (such as over-the-top (OTT) applications, YouTube, XR applications). In another case, the UE may determine that the expected traffic pattern is associated with a relatively light volume based on the application having a large amount of buffering data. Additionally, the UE may determine that the expected traffic pattern is associated with an increase in the volume of the traffic when a buffering request is triggered by the application, and the UE may identify a larger bandwidth part for the bandwidth part switch in advance of the buffering request. In another case, the UE may determine that the expected traffic pattern is associated with an increase in the volume of the traffic based on a user clicking a link in a web browsing application (e.g., when a website is updated at the UE).

Based on the UE determining the expected traffic pattern, the UE may identify a bandwidth part for the bandwidth part switch of the UE. For example, if the UE determines that the expected traffic pattern is associated with an increase in volume or delay sensitive traffic, the UE may identify a larger bandwidth part for the bandwidth part switch. Additionally, if the UE determines that the expected traffic pattern is associated with a decrease in volume or traffic that is not delay sensitive, the UE may identify a smaller bandwidth part for the bandwidth part switch. In some cases, if an application associated with high priority traffic (e.g., delay sensitive traffic) or a large volume of traffic is running in the background, the UE may determine to not switch to a larger bandwidth part.

In the example 400, the UE may identify a larger bandwidth part 450 for the bandwidth part switch of the UE. In some cases, the UE may identify the larger bandwidth part 450 based on determining that the expected traffic pattern associated with communications at the UE is associated a high data rate (e.g., a higher volume of traffic), includes traffic that is delay-sensitive (e.g., includes traffic that is high priority), or is bursty.

Based on identifying the bandwidth part 450 for the bandwidth switch, the UE may transmit uplink control signaling 415 requesting the bandwidth switch of the UE. In some cases, the uplink control signaling 415 may correspond to layer 1 UCI, layer 2 MAC-CE signaling, or layer 3 RRC signaling. The uplink control signaling 415 may include an indication of a UE-initiated bandwidth part switch. In some cases, the uplink control signaling 415 may also include an indication of the identified bandwidth part 450 (e.g., the bandwidth part identifier of the bandwidth part 450). Additionally, the uplink control signaling may include an indication of an amount of time associated with the UE communicating via the bandwidth part 450. Here, the UE may switch from communicating via the bandwidth part 450 to communicating via another bandwidth part (e.g., the bandwidth part 455) after communicating via the bandwidth part 450 for the amount of time indicated in the uplink control signaling 415 (e.g., unless the network node transmits a bandwidth part switching command to the UE while the UE is communicating via the bandwidth part 450).

The UE may switch from communicating via the bandwidth part 440 to communicating via the bandwidth part 450. In some cases, there may be a delay 420 associated with a switching delay between a time that the UE transmits the uplink control signaling 430 indicating the bandwidth part switch of the UE and a time that the UE begins communicating via the bandwidth part 450. In some cases, the delay 420 may correspond to the bandwidth part switch delay T described with reference to FIG. 3 and Table 1. Additionally, the delay 420 may not be associated with the serving cell switching delay Y described with reference to FIG. 3.

In one example, the network node may configure the UE to perform the UE-initiated bandwidth part switch autonomously. Here, the UE may switch to the bandwidth part 450 based on transmitting the uplink control signaling 415 indicating the bandwidth part switch, and without receiving any communication from the network node indicating whether the request to perform the bandwidth part switch of the UE is approved. In another example, the network node may transmit signaling indicating whether the UE is to switch to the bandwidth part 450 (e.g., approving the request for the bandwidth part switch of the UE or denying the request for the bandwidth part switch of the UE). In this example, the UE may refrain from performing the bandwidth part switch of the UE to the bandwidth part 450 until the UE receives a message indicating that the UE is to perform the bandwidth part switch.

Based on switching to the bandwidth part 450, the UE may communicate with the network node via the bandwidth part 450. For example, the network node may transmit, and the UE may receive, heavy downlink traffic 425 via the bandwidth part 450. In some cases, “heavy downlink traffic” may refer to downlink traffic that is associated with a relatively high data rate or downlink traffic that is associated with a bursty traffic pattern. A latency associated with the heavy downlink traffic 425 may be reduced based on the UE receiving the heavy downlink traffic 425 via the larger bandwidth part 450 (e.g., as compared to receiving the heavy downlink traffic 425 via the narrower bandwidth part 440).

In the example 400, the UE receives four communications corresponding to heavy downlink traffic 425 via the bandwidth part 450. After receiving the heavy downlink traffic 425, the UE does not communicate via the bandwidth part 450. Based on not transmitting or receiving communications via the bandwidth part 450, the UE may start an inactivity timer. The network node may configure the UE to switch to a default bandwidth part after the inactivity timer expires (e.g., after the inactivity timer duration 435). In the example 400, the UE may determine that the expected traffic pattern associated with communications at the UE is associated with light downlink traffic, and may therefore determine to switch the UE from the larger bandwidth part 450 to the narrower default bandwidth part 455 prior to the inactivity timer expiration. Accordingly, the UE may transmit uplink control signaling 430 indicating the switch of the UE from the bandwidth part 450 to the bandwidth part 455. The bandwidth part 455 may be the same as the bandwidth part 440 or different from the bandwidth part 440.

In some cases, the UE relying on the additional information related to the predicted volume and characteristic of the traffic at the UE may improve a latency associated with communications at the UE and decrease a power consumption of the UE. For example, the UE may determine the expected traffic pattern (e.g., and changes associated with the expected traffic pattern) earlier than the network node. Accordingly, UE-initiated bandwidth part switching may be associated with less latency than network-node-initiated bandwidth part switching. If the UE initiates a bandwidth part switch to a larger bandwidth part, a latency associated with the communications may be improved (e.g., as compared to a network-node-initiated bandwidth part switch to the larger bandwidth part). Additionally, if the UE initiates a bandwidth part switch to a smaller bandwidth part, a power consumption of the UE may be decreased (e.g., as compared to a network-node-initiated bandwidth part switch to the smaller bandwidth part).

As indicated above, FIG. 4 is provided as an example. Other examples may differ from what is described with respect to FIG. 4.

FIG. 5 is a diagram illustrating an example 500 of a UE-initiated bandwidth part switching, in accordance with the present disclosure. As shown in FIG. 5, a network node 110 and a UE 120 may communicate with one another. In some cases, the example 500 may include aspects of the UE-initiated bandwidth part switching described with reference to FIG. 4. For example, the bandwidth part 440 may be an example of the first bandwidth part described with reference to example 500, the bandwidth part 450 may be an example of the second bandwidth part described with reference to example 500, and the bandwidth part 455 may be an example of the third bandwidth part described with reference to example 500.

As shown by reference number 505, the network node 110 may transmit, and the UE 120 may receive, configuration information. In some cases, the network node 110 may transmit the configuration using RRC signaling, DCI, or a MAC-CE. The configuration information may indicate one or more bandwidth part configurations for communications between the UE 120 and the network node 110. As an example, a bandwidth part configuration may include an indication of the frequency resources associated with the bandwidth part (e.g., the subset of the full channel bandwidth that corresponds to the bandwidth part) and a corresponding bandwidth part identifier.

The configuration information may also configure one or more parameters associated with the bandwidth part configurations. For example, the configuration information may configure an inactivity timer associated with one or more of the configured bandwidth parts. In some cases, the configuration of the inactivity timer associated with a configured bandwidth part may indicate a duration of time during which the UE may be inactive (e.g., may not be transmitting or receiving via the configured bandwidth part) prior to switching from the configured bandwidth part to a default bandwidth part. In some cases, the configuration of the inactivity timer may indicate a range for the inactivity duration for the bandwidth part. For example, the configuration information may indicate a minimum amount of time that the UE may be inactive on the configured bandwidth part prior to switching to the default bandwidth part and a maximum amount of time that the UE may be inactive on the configured bandwidth part prior to switching to the default bandwidth part. By configuring a range for the inactivity timer, the UE 120 may have more flexibility as to when the UE 120 switches from communicating via the configured bandwidth part to communicating via the default bandwidth part (e.g., as compared to instances where the network node 110 configures a single value for the inactivity timer, or as compared to instances where the network node 110 configures the minimum and maximum values associated with the inactivity timer to be the same value).

The configuration information may additionally indicate one or more bandwidth parts for UE-initiated bandwidth part switching. That is, the configuration information may indicate, from the set of configured bandwidth parts, one or more bandwidth parts to which the UE 120 may initiate bandwidth part switching. In some cases, the network node 110 may indicate that the UE 120 may initiate bandwidth part switching to all of the configured bandwidth parts. In some other cases, the network node 110 may indicate a subset of a set of configured bandwidth parts to which the UE 120 may initiate bandwidth part switching (e.g., where the subset includes fewer bandwidth parts than the set of configured bandwidth parts). The configuration information may indicate the one or more bandwidth parts to which the UE 120 may initiate bandwidth part switching by including the bandwidth part identifiers of the one or more bandwidth parts within the configuration information.

The configuration information may also include an indication of one or more performance indicators associated with UE-initiated bandwidth part switching. For example, the performance indicators may include a number of times that the UE 120 may perform a UE-initiated bandwidth part switch due to an expiration of an inactivity timer, versus due to receiving PDCCH signaling, versus due to receiving RRC signaling, versus due to performing a RACH operation. Additionally, or alternatively, the performance indicators may include an amount of time between a bandwidth part switch of the UE due to an expiration of an inactivity timer, and a network-node-initiated bandwidth part switch of the UE 120 to a dedicated bandwidth part. Additionally, or alternatively, the performance indicators may include a number of times that a UE-initiated bandwidth part switch occurs within a dedicated bandwidth part due to higher or lower bandwidth requirements for communications at the UE 120. Additionally, or alternatively, the performance indicators may include an indication of a capability of a configured bandwidth part to serve different traffic profiles (which may enable the UE 120 to request bandwidth part switches to a bandwidth part based on the traffic pattern and traffic characteristics that are known to the UE 120). The performance indicators may also include one or more metrics associated with a power impact due to an inactive timer value in a configured bandwidth part.

In some cases, the network node 110 may adjust the UE-initiated bandwidth part switching configuration for the UE 120 based on whether the bandwidth part switching performed by the UE 120 satisfies the one or more performance indicators. For example, the network node 110 may restrict UE-initiated bandwidth part switching (e.g., by reducing an allowed time duration for communications by the UE 120 on a bandwidth part after the UE 120 initiates a switch to the bandwidth part, by decreasing a range of the inactivity timer) if the UE-initiated bandwidth switching of the UE 120 does not satisfy the one or more performance indicators. Additionally, or alternatively, the network node 110 may restrict UE-initiated bandwidth part switching based on congestion. For example, if a volume of traffic at the network node 110 exceeds a threshold, the network node 110 may restrict the UE-initiated bandwidth part switching of the UE 120 (and one or more other UEs 120 being served by the network node 110).

At 510, the UE 120 may communicate via the first bandwidth part. For example, the UE 120 may transmit one or more communications to the network node 110 via the first bandwidth part. Additionally, or alternatively, the UE 120 may receive one or more communications from the network node 110 via the first bandwidth part. In some cases, the first bandwidth part may correspond to a bandwidth part that is activated by the configuration information.

At 515, the network node 110 may transmit, and the UE 120 may receive, an indication that UE-initiated bandwidth part switching is allowed. For example, the network node 110 may transmit control signaling (e.g., DCI, RRC signaling, a MAC-CE) indicating that the UE-initiated bandwidth part switching is allowed. In some cases, the network node 110 may transmit the indication of whether the UE-initiated bandwidth part switching is allowed via DCI to enable a flexible configuration and reconfiguration of UE-initiated bandwidth part switching. In this example, the DCI may be a PDSCH or PUSCH scheduling DCI, a special format DCI, a group DCI, or some other DCI format.

The control signaling may additionally include an indication of an amount of time that the UE 120 may communicate via a bandwidth part after the UE-initiated bandwidth part switch to the bandwidth part (e.g., and prior to switching back to a default bandwidth part for communications with the network node 110). For example, the control signaling may indicate a threshold amount of time associated with communicating via a bandwidth part after the UE-initiated bandwidth part switch to the bandwidth part. Here, the UE 120 may communicate via the bandwidth part for a duration that is less than or equal to the threshold amount of time. In some cases, the UE 120 may start a timer that is set to the threshold amount of time based on switching to the bandwidth part, and may switch to communicating via a default bandwidth part prior to an expiration of the timer.

In some instances, the control signaling may also include an indication of an earliest time allowed for the UE-initiated bandwidth part switching. That is, the network node 110 may indicate, to the UE 120 via the control signaling, the earliest time that the UE 120 may transmit a request to perform a bandwidth part switch of the UE 120. In one example, the control signaling may indicate a timer value (e.g., associated with a prohibit timer) that is indicative of the earliest time that the UE 120 may initiate a bandwidth part switch. Here, the UE 120 may set a timer to the timer value (e.g., may initialize a timer to the timer value and start the timer based on a time that the control signaling is received from the network node 110) and may transmit a request to switch the bandwidth part of the UE 120 after an expiration of the timer. That is, the timer value may correspond to a minimum amount of time between the UE 120 receiving the control signaling and the UE 120 transmitting the request. In another example, the control signaling may not set the timer value (e.g., may not indicate a value for the prohibit timer). Here, the UE 120 may determine that the UE 120 may transmit a request to switch the bandwidth part of the UE 120 at any time after receiving the control signaling. That is, the earliest time allowed for the UE-initiated bandwidth part switching corresponds to the time that the UE 120 receives the control signaling.

The control signaling may additionally configure the UE-initiated bandwidth part switching as autonomous UE-initiated bandwidth part switching or a request mode of UE-initiated bandwidth part switching. In a first example, the control signaling may indicate for the UE 120 to perform autonomous UE-initiated bandwidth part switching. Here, the UE 120 may autonomously switch bandwidth parts without receiving any message from the network node 110 confirming a request from the UE 120 to perform the bandwidth part switch of the UE 120. In another example, the control signaling may indicate for the UE 120 to perform request mode UE-initiated bandwidth part switching. Here, the UE 120 may not perform a bandwidth part switch until the UE 120 receives a message from the network node 110 confirming a request from the UE 120 to perform the bandwidth part switch of the UE 120.

In some cases, the network node 110 may transmit the indication that the UE-initiated bandwidth part switching is allowed via different signaling than the configuration information illustrated at 505. Here, even if the UE 120 fails to detect or decode the indication that the UE-initiated bandwidth part switching is allowed, the UE 120 may still be capable of communicating with the network node 110 (e.g., based on successfully detecting and decoding the configuration information), but may not initiate any bandwidth part switching. In some other cases, the network node 110 may indicate that the UE-bandwidth part switching is allowed within the configuration information illustrated at 505.

At 520, the network node 110 may optionally transmit, and the UE 120 may optionally receive, assistance information. The assistance information from the network node 110 may provide the UE 120 with additional information related to an expected traffic pattern associated with communications at the UE 120. The assistance information may include, for example, traffic pattern information associated with a flow (e.g., periodicity information associated with a data flow, jitter information associated with a data flow), a quality of service requirement associated with a flow (e.g., an importance or priority associated with data in a flow, a protocol data unit (PDU) set delay budget (PSDB) associated with the flow), or a buffer size of a downlink buffer at the network node 110. Additionally, or alternatively, the assistance information may include feedback for previous UE-initiated bandwidth part switching of the UE 120. The feedback may correspond to performance feedback related to one or more previous bandwidth part switches initiated by the UE 120. If the network node 110 transmits the assistance information to the UE 120, the UE 120 may use the assistance information to identify a bandwidth part for UE-initiated bandwidth part switching.

At 525, the UE 120 may identify a second bandwidth part for a UE-initiated bandwidth part switch of the UE 120. The UE 120 may identify the second bandwidth part based on an expected traffic pattern associated with communications at the UE 120. For example, if the UE 120 determines that the expected traffic pattern is associated with a higher volume of traffic, traffic that is a high priority, or traffic that is delay sensitive and/or has latency requirements, the UE 120 may identify a second bandwidth part that is larger (e.g., wider, that includes more resources in the frequency domain) than the first bandwidth part. Additionally, if the UE 120 determines that the expected traffic pattern is associated with a lower volume of traffic, traffic that is low priority, or traffic that is not delay sensitive and/or that does not have stringent latency requirements, the UE 120 may identify a second bandwidth part that is narrower (e.g., smaller, that includes fewer resources in the frequency domain) than the first bandwidth part.

In some cases, the UE 120 may determine the expected traffic pattern associated with communications at the UE 120 based on one or more applications being executed by the UE 120, an application buffer status at the UE 120, a timing of expected traffic arriving at the UE 120, a volume of the expected traffic, or a priority of the expected traffic. Additionally, the UE 120 may rely on the assistance information received from the network node 110 at 520 to determine the expected traffic pattern. Additionally, the UE 120 may rely on other information to determine the expected traffic pattern. For example, the UE 120 may determine the expected traffic pattern based on whether each application being executed by the UE 120 is a front running application or being run in the background, a pattern of application use by a user of the UE 120, one or more inputs received from a user of the UE 120 (e.g., a user clicking a link on a web browsing application, a user initiating a download within an application being executed by the UE 120), or information related to a modem of the UE 120.

The UE 120 may identify the second bandwidth part for the UE-initiated bandwidth part switch based on executing an AI/ML model. For example, the UE 120 may input one or more parameters related to the expected traffic pattern, the assistance information received from the network node 110 at 520, and one or more other parameters related to the operations at the UE 120 (e.g., a power saving mode of the UE 120, feedback received from the network node 110 related to previous bandwidth part switches of the UE 120) into the AI/ML model. Here, the AI/ML model may output an indication of the second bandwidth part for the UE-initiated bandwidth part switch.

The UE 120 may update the AI/ML model based on the one or more performance indicators received from the network node 110 (e.g., within the configuration information or within control signaling). That is, the UE 120 may update the AI/ML model to satisfy one or more performance metrics indicated by the performance indicators. For example, if the performance indicators include an indication of a scheduling in each bandwidth part, the UE 120 may update the AI/ML model based on the scheduling in each bandwidth part. Additionally, the UE 120 may update the AI/ML model based on a number of dedicated bandwidth parts configured and the capabilities of each configured dedicated bandwidth part to serve different traffic profiles. Further, the UE 120 may update the AI/ML model based on a number of times that a UE-initiated bandwidth part switch to a bandwidth part occurs due to higher or lower bandwidth requirements for communications at the UE 120.

In some cases, if the UE 120 initiates bandwidth part switching of the UE 120 to bandwidth parts (e.g., indicated by the AI/ML model) that fail to satisfy the one or more performance metrics indicated by the performance indicators, the network node 110 may reconfigure the UE-initiated bandwidth part switching of the UE 120 (e.g., to restrict the UE-initiated bandwidth part switching of the UE 120). Accordingly, the UE 120 may update the AI/ML model to increase a likelihood that UE-initiated bandwidth part switches to a bandwidth part indicated by an output of the AI/ML model satisfy the performance metrics.

In some cases, the network node 110 may additionally update a radio resource management (e.g., associated with the UE-initiated bandwidth part switching of the UE 120) based on the performance metrics of UE-initiated bandwidth part switching of the UE 120. For example, if an amount of time between a bandwidth part switch of the UE due to an expiration of an inactivity timer and a network-node-initiated bandwidth part switch of the UE 120 to a dedicated bandwidth part is relatively large, the network node 110 may update a configuration to increase a length of the inactivity timer.

Additionally if the amount of time is relatively small, the network node 110 may update the configuration to decrease the length of the inactivity timer.

The UE 120 may additionally update the AI/ML model based on feedback received from the network node 110. For example, the network node 110 may provide performance feedback related to previous UE-initiated bandwidth part switches of the UE 120. The UE 120 may then update the AI/ML model based on the feedback. In some cases, the UE 120 may update the AI/ML model based on the feedback on a per-flow basis. In some cases, the UE 120 may use an updated AI/ML model to identify the second bandwidth part at 525.

At 530, the UE 120 may transmit, and the network node 110 may receive, a request to switch a bandwidth part of the UE 120. The UE 120 may transmit the request via layer 1 UCI, layer 2 MAC-CE signaling, or layer 3 RRC signaling. In some cases, the request may include an indication of the second bandwidth part. For example, the request may include the bandwidth part identifier of the second bandwidth part.

Additionally, the UE 120 may indicate, within the request, a duration associated with the UE 120 communicating via the second bandwidth part (e.g., a preferred duration of communicating via the second bandwidth part). The UE 120 may indicate the duration by indicating a number of milliseconds of the duration, a number of subframes of the duration, or a number of slots of the duration. If the UE 120 indicates the duration within the request, the UE 120 may communicate via the second bandwidth part for an amount of time that is less than or equal to the duration indicated in the request. Then, the UE 120 may switch to communicating with the network node 110 via another bandwidth part (e.g., a third bandwidth part).

In some instances, the UE 120 may be communicating periodic traffic. For example, the UE 120 may be communicating XR traffic, which may be periodic. Here, the UE 120 may identify a periodic bandwidth part switch of the UE 120 to the second bandwidth part (e.g., at 525). In this example, the UE 120 may request a periodic bandwidth part switch of the UE 120 to the second bandwidth part. That is, the UE 120 may indicate, within the request, a periodicity of the bandwidth part switching to the second bandwidth part. In some cases, the UE 120 may indicate an integer periodicity or a non-integer periodicity, or a unit associated with the periodicity (e.g., the periodicity in Hz or in frames per second) within the request. Additionally, or alternatively, the UE 120 may transmit the request to add, modify, or delete one or more periodic bandwidth part switches of the UE 120 to the second bandwidth part. For example, the UE 120 and the network node 110 may have previously configured the periodic bandwidth part switching of the UE 120 to the second bandwidth part. Here, the UE 120 may transmit the request indicating an addition, modification, or deletion of one or more of the periodic bandwidth part switches of the UE 120 to the second bandwidth part. In some cases, the UE 120 may request the update to the periodic bandwidth part switching configuration of the UE 120 by including an identifier associated with the periodic bandwidth part switching configuration of the UE 120 in the request.

In some cases (e.g., if the UE 120 is not requesting a periodic bandwidth part switch of the UE 120 to the second bandwidth part), the UE 120 may indicate a periodicity of ‘0’ to transmit a request that is not for a periodic bandwidth part switch of the UE (e.g., and to overwrite the periodic configuration within the request).

Based on transmitting the request to switch the bandwidth part of the UE 120, the UE 120 may proceed to 535 or 540. In a first example, where the network node 110 indicates for the UE 120 to perform UE-initiated bandwidth part switching autonomously, the UE 120 may proceed to 540. That is, the UE 120 may switch to communicating via the second bandwidth part after transmitting the request (e.g., and without receiving an indication from the network node 110 to switch to the second bandwidth part). In some cases, the autonomous UE-initiated bandwidth part switching may decrease a power consumption associated with bandwidth part switching (e.g., as compared to the request mode of UE-initiated bandwidth part switching). In a second example, where the network node 110 indicates for the UE 120 to perform a request mode of UE-initiated bandwidth part switching, the UE 120 may proceed to 535. That is, the UE 120 may not switch to communicating via the second bandwidth part until the UE 120 receives an indication, from the network node 110, to switch the bandwidth part of the UE 120. In some cases, the request mode of the UE-initiated bandwidth part switching may improve a coordination between the UE 120 and the network node (e.g., as compared to the autonomous mode of the UE-initiated bandwidth part switching).

At 535, the network node 110 may optionally transmit, and the UE 120 may optionally receive, a message including an indication to switch the bandwidth part of the UE 120. For example, the network node 110 may determine whether to confirm the request from the UE 120 to perform the bandwidth part switching of the UE 120. Then, the network node 110 may transmit the message indicating, to the UE 120, whether the UE 120 is to switch the bandwidth part of the UE 120. In the example 500, the network node 110 may transmit an indication for the UE 120 to switch the bandwidth part of the UE 120. In some cases, the message may include a bandwidth part switching command. Here, the bandwidth part switching command may include an identifier of the bandwidth part for the bandwidth part switch (e.g., the identifier of the second bandwidth part). Additionally, the message may include an indication of a threshold amount of time associated with the bandwidth part switch. That is, the message may indicate for the UE 120 to return to a default bandwidth part (e.g., the third bandwidth part) after a duration that is less than the threshold amount of time. Here, the UE 120 may communicate via the second bandwidth part for a duration that is less than or equal to the threshold amount of time. In some cases, the UE 120 may start a timer that is set to the threshold amount of time based on switching to the second bandwidth part, and may switch to communicating via a default bandwidth part prior to an expiration of the timer.

At 540, the UE 120 may communicate with the network node 110 via the second bandwidth part. For example, the UE 120 may transmit one or more communications to the network node 110 via the second bandwidth part. Additionally, or alternatively, the UE 120 may receive one or more communications from the network node 110 via the second bandwidth part.

At 545, the UE 120 may optionally transmit an indication to switch the bandwidth part of the UE 120. For example, at 545 the UE 120 may transmit a fallback indication to the network node 110. That is, the indication may indicate that the UE 120 is switching from communicating via the second bandwidth part to communicating via a default bandwidth part (e.g., a third bandwidth part). The UE 120 may transmit this indication to the network node 110 via PHY signaling (e.g., UCI) or MAC signaling (e.g., a MAC-CE). The UE 120 may transmit the indication (e.g., the fallback indication) within a range of the inactivity timer configured by the network node 110. Additionally, if the network node 110 indicates a duration for the UE-initiated bandwidth part switch of the UE 120, the UE 120 may transmit the indication within the range of the timer associated with that duration. In some cases, the indication may additionally include an indication of the third bandwidth part (e.g., an identifier of the third bandwidth part). That is, the indication may indicate that the UE 120 is switching back to a default bandwidth part (e.g., the third bandwidth part is the third bandwidth part) or a bandwidth part that is different from the default bandwidth part (e.g., the third bandwidth part is not the default bandwidth part). In some cases, the UE 120 may determine to fallback (e.g., to switch from the second bandwidth part) to a bandwidth part that is different from the default bandwidth part based on a bandwidth of the default bandwidth part and an amount of data within the expected traffic expected by the UE 120. In either case, the UE 120 may optionally indicate a bandwidth identifier of the third bandwidth part within the fallback indication.

At 550, the UE 120 may switch from communicating via the second bandwidth part to communicating via the third bandwidth part. For example, the UE 120 may transmit one or more communications to the network node 110 via the third bandwidth part. Additionally, or alternatively, the UE 120 may receive one or more communications from the network node 110 via the third bandwidth part.

As indicated above, FIG. 5 is provided as an example. Other examples may differ from what is described with respect to FIG. 5.

FIG. 6 is a diagram illustrating an example 600 of a network-node-initiated bandwidth part switching, in accordance with the present disclosure. As shown in FIG. 6, a network node 110 and a UE 120 may communicate with one another.

As shown by reference number 605, the UE 120 may communicate via the first bandwidth part. For example, the UE 120 may transmit one or more communications to the network node 110 via the first bandwidth part. Additionally, or alternatively, the UE 120 may receive one or more communications from the network node 110 via the first bandwidth part. In some cases, the first bandwidth part may correspond to a bandwidth part that is activated by configuration information transmitted by the network node 110 to the UE 120 (not illustrated).

At 610, the UE 120 may transmit, and the network node 110 may receive, an indication of one or more parameters associated with communications at the UE 120. The one or more parameters may include one or more applications being executed by the UE 120, an application buffer status at the UE 120, a timing of expected traffic arriving at the UE 120, a volume of the expected traffic, or a priority of the expected traffic. Additionally, the one or more parameters may include an indication of whether each application being executed by the UE 120 corresponds to a front-running application or a background-running application. The one or more parameters may also include an indication of an event that is expected by the UE 120 that may impact the traffic pattern associated with communications at the UE 120. Here, the one or more parameters may also include an indication of a traffic arrival timing and volume prediction associated with the event. The UE 120 may transmit the indication of the one or more parameters via UCI, a MAC-CE, or RRC signaling. If the UE 120 transmits the indication via RRC signaling, the UE 120 may transmit the indication within UE assistance information in the RRC signaling.

The network node 110 may configure the UE 120 to transmit the indication of the one or more parameters. For example, the network node 110 may transmit control signaling indicating for the UE 120 to transmit an indication of the one or more parameters, to the network node 110, according to a periodicity. In some cases, the UE 120 transmitting the indication of the one or more parameters more frequently may improve a performance of the bandwidth part switching, but may also increase a power consumption at the UE.

At 615, the network node 110 may identify a second bandwidth part for a bandwidth part switch of the UE 120. The network node 110 may identify the second bandwidth part based on an expected traffic pattern associated with communications at the UE 120. For example, if the network node 110 determines that the expected traffic pattern is associated with a higher volume of traffic, traffic that is a high priority, or traffic that is delay sensitive and/or has latency requirements, the network node 110 may identify a second bandwidth part that is larger (e.g., wider, that includes more resources in the frequency domain) than the first bandwidth part. Additionally, if the network node 110 determines that the expected traffic pattern is associated with a lower volume of traffic, traffic that is low priority, or traffic that is not delay sensitive and/or that does not have stringent latency requirements, the network node 110 may identify a second bandwidth part that is narrower (e.g., smaller, that includes fewer resources in the frequency domain) than the first bandwidth part.

In some cases, the network node 110 may determine the expected traffic pattern associated with communications at the UE 120 based on the one or more parameters indicated to the network node 110 by the UE 120 (e.g., at 610). For example, the network node 110 may determine the expected traffic pattern associated with communications at the UE 120 based on the one or more applications being executed by the UE 120, the application buffer status at the UE 120, the timing of expected traffic arriving at the UE 120, the volume of the expected traffic, or the priority of the expected traffic. Additionally, the network node 110 may rely on additional information related to communications with the UE 120 that is known to the network node 110 to determine the expected traffic pattern. For example, the network node 110 may additionally use traffic pattern information associated with a flow (e.g., periodicity information associated with a data flow, jitter information associated with a data flow) between the network node 110 and the UE 120, a quality of service requirement associated with the flow (e.g., an importance or priority associated with data in a flow, a PSDB associated with the flow), or a buffer size of a downlink buffer at the network node 110.

The network node 110 may identify the second bandwidth part for the UE-initiated bandwidth part switch based on executing an AI/ML model. For example, the network node 110 may input one or more parameters related to the expected traffic pattern and/or the additional information related to communications with the UE 120 that is known to the network node 110 into the AI/ML model. The AI/ML model may output an indication of the second bandwidth part for the UE-initiated bandwidth part switch. The network node 110 may update the AI/ML model based on one or more performance indicators associated with bandwidth part switching of the UE 120. That is, the network node 110 may update the AI/ML model to satisfy one or more performance metrics indicated by the performance indicators. That is, the network node 110 may update the AI/ML model based on one or more previous bandwidth part switches of the UE 120.

At 620, the network node 110 may transmit, and the UE 120 may receive, a bandwidth part switching command indicating for the UE 120 to switch from communicating via the first bandwidth part to communicating via the second bandwidth part.

At 625, the UE 120 may communicate with the network node 110 via the second bandwidth part. For example, the UE 120 may transmit one or more communications to the network node 110 via the second bandwidth part. Additionally, or alternatively, the UE 120 may receive one or more communications from the network node 110 via the second bandwidth part.

As indicated above, FIG. 6 is provided as an example. Other examples may differ from what is described with respect to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with techniques for bandwidth part switching.

As shown in FIG. 7, in some aspects, process 700 may include receiving control signaling indicating that UE-initiated bandwidth part switching is allowed (block 710). For example, the UE (e.g., using reception component 1102 and/or communication manager 1106, depicted in FIG. 11) may receive control signaling indicating that UE-initiated bandwidth part switching is allowed, as described above.

As further shown in FIG. 7, in some aspects, process 700 may include transmitting, based at least in part on the UE-initiated bandwidth part switching being allowed, a request to switch a bandwidth part of the UE (block 720). For example, the UE (e.g., using transmission component 1104 and/or communication manager 1106, depicted in FIG. 11) may transmit, based at least in part on the UE-initiated bandwidth part switching being allowed, a request to switch a bandwidth part of the UE, as described above.

As further shown in FIG. 7, in some aspects, process 700 may include switching from communicating via a first bandwidth part to communicating via a second bandwidth part based at least in part on the transmission of the request to switch the bandwidth part of the UE (block 730). For example, the UE (e.g., using communication manager 1106, depicted in FIG. 11) may switch from communicating via a first bandwidth part to communicating via a second bandwidth part based at least in part on the transmission of the request to switch the bandwidth part of the UE, as described above.

Process 700 may include additional aspects, such as any single aspect or any combination of aspects described below and/or in connection with one or more other processes described elsewhere herein.

In a first aspect, the control signaling indicates for the UE to perform the UE-initiated bandwidth part switching autonomously, and process 700 includes switching to communicating via the second bandwidth part autonomously based at least in part on the transmission of the request.

In a second aspect, alone or in combination with the first aspect, process 700 includes receiving a message indicating whether the UE is to switch the bandwidth part of the UE based at least in part on the transmission of the request, wherein the switch to communicating via the second bandwidth part is based at least in part on the message indicating for the UE to switch the bandwidth part of the UE.

In a third aspect, alone or in combination with one or more of the first and second aspects, the message comprises an identifier of the second bandwidth part, and the switch to communicating via the second bandwidth part is based at least in part on the message comprising the identifier of the second bandwidth part.

In a fourth aspect, alone or in combination with one or more of the first through third aspects, the message indicates a threshold amount of time associated with the communicating via the second bandwidth part, and process 700 includes communicating via the second bandwidth part for a duration that is less than or equal to the threshold amount of time, and switching from communicating via the second bandwidth part to communicating via a third bandwidth part after the duration.

In a fifth aspect, alone or in combination with one or more of the first through fourth aspects, process 700 includes identifying the second bandwidth part for the UE-initiated bandwidth part switching based at least in part on an expected traffic pattern associated with communications at the UE, wherein the transmission of the request is based at least in part on the identifying.

In a sixth aspect, alone or in combination with one or more of the first through fifth aspects, the expected traffic pattern associated with the communications at the UE is based at least in part on an application executed by the UE, an application buffer status at the UE, a timing of expected traffic arriving at the UE, a volume of the expected traffic, or a priority of the expected traffic.

In a seventh aspect, alone or in combination with one or more of the first through sixth aspects, process 700 includes receiving, from a network node, assistance information associated with the expected traffic pattern, wherein the assistance information comprises one or more quality of service requirements, a downlink buffer size of the network node, or feedback related to a previous UE-initiated bandwidth part switching performed by the UE, and wherein the identifying is based at least in part on the assistance information.

In an eighth aspect, alone or in combination with one or more of the first through seventh aspects, identifying the second bandwidth part comprises executing an AI/ML model, wherein an input to the AI/ML model comprises one or more parameters associated with the expected traffic pattern, the assistance information, or both, and wherein an output of the AI/ML model comprises an indication of the second bandwidth part for the UE-initiated bandwidth part switching.

In a ninth aspect, alone or in combination with one or more of the first through eighth aspects, process 700 includes receiving, from the network node, an indication of one or more performance indicators associated with the UE-initiated bandwidth part switching to the second bandwidth part, wherein the input to the AI/ML model further comprises the one or more performance indicators.

In a tenth aspect, alone or in combination with one or more of the first through ninth aspects, the request comprises an indication of the second bandwidth part.

In an eleventh aspect, alone or in combination with one or more of the first through tenth aspects, the request comprises an indication of a duration associated with communicating via the second bandwidth part, an indication of a periodicity associated with the bandwidth part switching operation, or both.

In a twelfth aspect, alone or in combination with one or more of the first through eleventh aspects, process 700 includes receiving configuration information indicating one or more bandwidth parts, including at least the second bandwidth part, for the UE-initiated bandwidth part switching.

In a thirteenth aspect, alone or in combination with one or more of the first through twelfth aspects, process 700 includes communicating via the second bandwidth part for a duration based at least in part on the switch, and switching from communicating via the second bandwidth part to communicating via a third bandwidth part after the duration.

In a fourteenth aspect, alone or in combination with one or more of the first through thirteenth aspects, the control signaling indicates a threshold amount of time associated with the UE-initiated bandwidth part switching, and the duration for communicating via the second bandwidth part is less than or equal to the threshold amount of time.

In a fifteenth aspect, alone or in combination with one or more of the first through fourteenth aspects, process 700 includes transmitting, based at least in part on starting an inactivity timer during the duration, signaling indicating the switch from communicating via the second bandwidth part, wherein the switch to communicating via the third bandwidth part is based at least in part on the transmission of the signaling.

In a sixteenth aspect, alone or in combination with one or more of the first through fifteenth aspects, the signaling comprises an indication of the third bandwidth part.

In a seventeenth aspect, alone or in combination with one or more of the first through sixteenth aspects, the control signaling comprises an indication of a timer value that is associated with an earliest time allowed for the UE-initiated bandwidth part switching, and the process 700 further includes setting a timer to the timer value, and transmitting the request after an expiration of the timer.

In an eighteenth aspect, alone or in combination with one or more of the first through seventeenth aspects, the control signaling indicates that an earliest time allowed for the UE-initiated bandwidth part switching corresponds to a time at which the UE receives the control signaling based at least in part on a timer value indicated by the control signaling not being set.

In a nineteenth aspect, alone or in combination with one or more of the first through eighteenth aspects, the control signaling corresponds to DCI, a MAC-CE, or RRC signaling.

In a twentieth aspect, alone or in combination with one or more of the first through nineteenth aspects, the request comprises UCI, a MAC-CE, or RRC signaling.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with techniques for bandwidth part switching.

As shown in FIG. 8, in some aspects, process 800 may include transmitting, to a network node, signaling indicating one or more parameters associated with an expected traffic pattern of communications at the UE (block 810). For example, the UE (e.g., using transmission component 1104 and/or communication manager 1106, depicted in FIG. 11) may transmit, to a network node, signaling indicating one or more parameters associated with an expected traffic pattern of communications at the UE, as described above.

As further shown in FIG. 8, in some aspects, process 800 may include receiving, from the network node, a bandwidth part switching command indicating for the UE to switch from communicating via a first bandwidth part to communicating via a second bandwidth part (block 820). For example, the UE (e.g., using reception component 1102 and/or communication manager 1106, depicted in FIG. 11) may receive, from the network node, a bandwidth part switching command indicating for the UE to switch from communicating via a first bandwidth part to communicating via a second bandwidth part, as described above.

Process 800 may include additional aspects, such as any single aspect or any combination of aspects described below and/or in connection with one or more other processes described elsewhere herein.

In a first aspect, the one or more parameters associated with the expected traffic pattern comprise one or more applications executed by the UE, an application buffer status at the UE, a timing of expected traffic arriving at the UE, a volume of the expected traffic, or a priority of the expected traffic.

In a second aspect, alone or in combination with the first aspect, the signaling indicating the one or more parameters associated with the expected traffic pattern corresponds to UCI, a MAC-CE, or RRC signaling.

In a third aspect, alone or in combination with one or more of the first and second aspects, receiving the bandwidth part switching command comprises receiving DCI, a MAC-CE, or RRC signaling.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with techniques for bandwidth part switching.

As shown in FIG. 9, in some aspects, process 900 may include receiving, from a UE, signaling indicating one or more parameters associated with an expected traffic pattern of communications at the UE (block 910). For example, the network node (e.g., using reception component 1202 and/or communication manager 1206, depicted in FIG. 12) may receive, from a UE, signaling indicating one or more parameters associated with an expected traffic pattern of communications at the UE, as described above.

As further shown in FIG. 9, in some aspects, process 900 may include identifying a bandwidth part switch of the UE from communicating via a first bandwidth part to communicating via a second bandwidth part based at least in part on an output of an AI/ML model, wherein the one or more parameters associated with the expected traffic pattern are input to the AI/ML model (block 920). For example, the network node (e.g., using communication manager 1206, depicted in FIG. 12) may identify a bandwidth part switch of the UE from communicating via a first bandwidth part to communicating via a second bandwidth part based at least in part on an output of an AI/ML model, wherein the one or more parameters associated with the expected traffic pattern are input to the AI/ML model, as described above. In some aspects, the one or more parameters associated with the expected traffic pattern are input to the AI/ML model.

As further shown in FIG. 9, in some aspects, process 900 may include transmitting, to the UE, a bandwidth part switching command indicating for the UE to switch from communicating via the first bandwidth part to communicating via the second bandwidth part (block 930). For example, the network node (e.g., using transmission component 1204 and/or communication manager 1206, depicted in FIG. 12) may transmit, to the UE, a bandwidth part switching command indicating for the UE to switch from communicating via the first bandwidth part to communicating via the second bandwidth part, as described above.

Process 900 may include additional aspects, such as any single aspect or any combination of aspects described below and/or in connection with one or more other processes described elsewhere herein.

In a first aspect, the one or more parameters associated with the expected traffic pattern comprise one or more applications executed by the UE, an application buffer status at the UE, a timing of expected traffic arriving at the UE, a volume of the expected traffic, or a priority of the expected traffic.

In a second aspect, alone or in combination with the first aspect, the output of the AI/ML model is an indication of the bandwidth part switch of the UE to communicating via the second bandwidth part.

In a third aspect, alone or in combination with one or more of the first and second aspects, the signaling indicating the one or more parameters associated with the expected traffic pattern corresponds to UCI, a MAC-CE, or RRC signaling.

In a fourth aspect, alone or in combination with one or more of the first through third aspects, transmitting the bandwidth part switching command comprises transmitting DCI, a MAC-CE, or RRC signaling.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with techniques for bandwidth part switching.

As shown in FIG. 10, in some aspects, process 1000 may include transmitting, to a UE, control signaling indicating that UE-initiated bandwidth part switching is allowed (block 1010). For example, the network node (e.g., using transmission component 1204 and/or communication manager 1206, depicted in FIG. 12) may transmit, to a UE, control signaling indicating that UE-initiated bandwidth part switching is allowed, as described above.

As further shown in FIG. 10, in some aspects, process 1000 may include receiving, from the UE and based at least in part on the UE-initiated bandwidth part switching being allowed, a request to switch a bandwidth part of the UE (block 1020). For example, the network node (e.g., using reception component 1202 and/or communication manager 1206, depicted in FIG. 12) may receive, from the UE and based at least in part on the UE-initiated bandwidth part switching being allowed, a request to switch a bandwidth part of the UE, as described above.

As further shown in FIG. 10, in some aspects, process 1000 may include switching from communicating with the UE via a first bandwidth part to communicating via a second bandwidth part based at least in part on the reception of the request to switch the bandwidth part of the UE (block 1030). For example, the network node (e.g., using communication manager 1206, depicted in FIG. 12) may switch from communicating with the UE via a first bandwidth part to communicating via a second bandwidth part based at least in part on the reception of the request to switch the bandwidth part of the UE, as described above.

Process 1000 may include additional aspects, such as any single aspect or any combination of aspects described below and/or in connection with one or more other processes described elsewhere herein.

In a first aspect, the control signaling indicates for the UE to perform the UE-initiated bandwidth part switching autonomously.

In a second aspect, alone or in combination with the first aspect, process 1000 includes transmitting, to the UE, a message indicating whether the UE is to switch the bandwidth part of the UE based at least in part on the reception of the request, wherein the switch to communicating via the second bandwidth part is based at least in part on the message indicating for the UE to switch the bandwidth part of the UE.

In a third aspect, alone or in combination with one or more of the first and second aspects, the message comprises an identifier of the second bandwidth part, and the switch to communicating via the second bandwidth part is based at least in part on the message comprising the identifier of the second bandwidth part.

In a fourth aspect, alone or in combination with one or more of the first through third aspects, the message indicates a threshold amount of time associated with the communicating via the second bandwidth part, and process 1000 includes communicating via the second bandwidth part for a duration that is less than or equal to the threshold amount of time, and switching from communicating with the UE via the second bandwidth part to communicating with the UE via a third bandwidth part after the duration.

In a fifth aspect, alone or in combination with one or more of the first through fourth aspects, process 1000 includes transmitting, to the UE, assistance information associated with an expected traffic pattern associated with communications at the UE, wherein the assistance information comprises one or more quality of service requirements, a downlink buffer size of the network node, or feedback related to a previous UE-initiated bandwidth part switching performed by the UE, and wherein the expected traffic pattern associated with the communications at the UE is based at least in part on an application executed by the UE, an application buffer status at the UE, a timing of expected traffic arriving at the UE, a volume of the expected traffic, or a priority of the expected traffic.

In a sixth aspect, alone or in combination with one or more of the first through fifth aspects, process 1000 includes transmitting, to the UE, an indication of one or more performance indicators associated with the UE-initiated bandwidth part switching to the second bandwidth part.

In a seventh aspect, alone or in combination with one or more of the first through sixth aspects, the request comprises an indication of the second bandwidth part.

In an eighth aspect, alone or in combination with one or more of the first through seventh aspects, the request comprises an indication of a duration associated with communicating via the second bandwidth part, an indication of a periodicity associated with the bandwidth part switching operation, or both.

In a ninth aspect, alone or in combination with one or more of the first through eighth aspects, process 1000 includes transmitting configuration information to the UE indicating one or more bandwidth parts, including at least the second bandwidth part, for the UE-initiated bandwidth part switching.

In a tenth aspect, alone or in combination with one or more of the first through ninth aspects, process 1000 includes communicating with the UE via the second bandwidth part for a duration based at least in part on the switch, and switching from communicating with the UE via the second bandwidth part to communicating with the UE via a third bandwidth part after the duration.

In an eleventh aspect, alone or in combination with one or more of the first through tenth aspects, the control signaling indicates a threshold amount of time associated with the UE-initiated bandwidth part switching, and the duration for communicating via the second bandwidth part is less than or equal to the threshold amount of time.

In a twelfth aspect, alone or in combination with one or more of the first through eleventh aspects, process 1000 includes receiving, from the UE, signaling indicating the switch from communicating via the second bandwidth part, wherein the switch to communicating via the third bandwidth part is based at least in part on the reception of the signaling.

In a thirteenth aspect, alone or in combination with one or more of the first through twelfth aspects, the signaling comprises an indication of the third bandwidth part.

In a fourteenth aspect, alone or in combination with one or more of the first through thirteenth aspects, the control signaling comprises an indication of a timer value that is associated with an earliest time allowed for the UE-initiated bandwidth part switching.

In a fifteenth aspect, alone or in combination with one or more of the first through fourteenth aspects, the control signaling indicates that an earliest time allowed for the UE-initiated bandwidth part switching corresponds to a time at which the UE receives the control signaling based at least in part on a timer value indicated by the control signaling not being set.

In a sixteenth aspect, alone or in combination with one or more of the first through fifteenth aspects, the control signaling corresponds to DCI, a MAC-CE, or RRC signaling.

In a seventeenth aspect, alone or in combination with one or more of the first through sixteenth aspects, the request comprises UCI, a MAC-CE, or RRC signaling.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 4-6. Additionally, or alternatively, the apparatus 1100 may be configured to perform one or more processes described herein, such as process 700 of FIG. 7, process 800 of FIG. 8, or a combination thereof. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive control signaling indicating that UE-initiated bandwidth part switching is allowed. The transmission component 1104 may transmit, based at least in part on the UE-initiated bandwidth part switching being allowed, a request to switch a bandwidth part of the UE. The communication manager 1106 may switch from communicating via a first bandwidth part to communicating via a second bandwidth part based at least in part on the transmission of the request to switch the bandwidth part of the UE.

The reception component 1102 may receive a message indicating whether the UE is to switch the bandwidth part of the UE based at least in part on the transmission of the request, wherein the switch to communicating via the second bandwidth part is based at least in part on the message indicating for the UE to switch the bandwidth part of the UE.

The communication manager 1106 may identify the second bandwidth part for the UE-initiated bandwidth part switching based at least in part on an expected traffic pattern associated with communications at the UE, wherein the transmission of the request is based at least in part on the identifying.

The reception component 1102 may receive, from a network node, assistance information associated with the expected traffic pattern, wherein the assistance information comprises one or more quality of service requirements, a downlink buffer size of the network node, or feedback related to a previous UE-initiated bandwidth part switching performed by the UE, and wherein the identifying is based at least in part on the assistance information.

The reception component 1102 may receive, from the network node, an indication of one or more performance indicators associated with the UE-initiated bandwidth part switching to the second bandwidth part, wherein the input to the AI/ML model further comprises the one or more performance indicators.

The reception component 1102 may receive configuration information indicating one or more bandwidth parts, including at least the second bandwidth part, for the UE-initiated bandwidth part switching.

The communication manager 1106 may communicate via the second bandwidth part for a duration based at least in part on the switch.

The communication manager 1106 may switch from communicating via the second bandwidth part to communicating via a third bandwidth part after the duration.

The transmission component 1104 may transmit, based at least in part on starting an inactivity timer during the duration, signaling indicating the switch from communicating via the second bandwidth part, wherein the switch to communicating via the third bandwidth part is based at least in part on the transmission of the signaling.

The transmission component 1104 may transmit, to a network node, signaling indicating one or more parameters associated with an expected traffic pattern of communications at the UE. The reception component 1102 may receive, from the network node, a bandwidth part switching command indicating for the UE to switch from communicating via a first bandwidth part to communicating via a second bandwidth part.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 4-6. Additionally, or alternatively, the apparatus 1200 may be configured to perform one or more processes described herein, such as process 900 of FIG. 9, process 1000 of FIG. 10, or a combination thereof. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a UE, signaling indicating one or more parameters associated with an expected traffic pattern of communications at the UE. The communication manager 1206 may identify a bandwidth part switch of the UE from communicating via a first bandwidth part to communicating via a second bandwidth part based at least in part on an output of an AI/ML model, wherein the one or more parameters associated with the expected traffic pattern are input to the AI/ML model. The transmission component 1204 may transmit, to the UE, a bandwidth part switching command indicating for the UE to switch from communicating via the first bandwidth part to communicating via the second bandwidth part.

The transmission component 1204 may transmit, to a UE, control signaling indicating that UE-initiated bandwidth part switching is allowed. The reception component 1202 may receive, from the UE and based at least in part on the UE-initiated bandwidth part switching being allowed, a request to switch a bandwidth part of the UE.

The communication manager 1206 may switch from communicating with the UE via a first bandwidth part to communicating via a second bandwidth part based at least in part on the reception of the request to switch the bandwidth part of the UE.

The transmission component 1204 may transmit, to the UE, a message indicating whether the UE is to switch the bandwidth part of the UE based at least in part on the reception of the request, wherein the switch to communicating via the second bandwidth part is based at least in part on the message indicating for the UE to switch the bandwidth part of the UE.

The transmission component 1204 may transmit, to the UE, assistance information associated with an expected traffic pattern associated with communications at the UE, wherein the assistance information comprises one or more quality of service requirements, a downlink buffer size of the network node, or feedback related to a previous UE-initiated bandwidth part switching performed by the UE, and wherein the expected traffic pattern associated with the communications at the UE is based at least in part on an application executed by the UE, an application buffer status at the UE, a timing of expected traffic arriving at the UE, a volume of the expected traffic, or a priority of the expected traffic.

The transmission component 1204 may transmit, to the UE, an indication of one or more performance indicators associated with the UE-initiated bandwidth part switching to the second bandwidth part.

The transmission component 1204 may transmit configuration information to the UE indicating one or more bandwidth parts, including at least the second bandwidth part, for the UE-initiated bandwidth part switching.

The communication manager 1206 may communicate with the UE via the second bandwidth part for a duration based at least in part on the switch.

The communication manager 1206 may switch from communicating with the UE via the second bandwidth part to communicating with the UE via a third bandwidth part after the duration.

The reception component 1202 may receive, from the UE, signaling indicating the switch from communicating via the second bandwidth part, wherein the switch to communicating via the third bandwidth part is based at least in part on the reception of the signaling.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving control signaling indicating that UE-initiated bandwidth part switching is allowed; transmitting, based at least in part on the UE-initiated bandwidth part switching being allowed, a request to switch a bandwidth part of the UE; and switching from communicating via a first bandwidth part to communicating via a second bandwidth part based at least in part on the transmission of the request to switch the bandwidth part of the UE.

Aspect 2: The method of Aspect 1, wherein: the control signaling indicates for the UE to perform the UE-initiated bandwidth part switching autonomously; and the method further comprises switching to communicating via the second bandwidth part autonomously based at least in part on the transmission of the request.

Aspect 3: The method of any of Aspects 1-2, further comprising: receiving a message indicating whether the UE is to switch the bandwidth part of the UE based at least in part on the transmission of the request, wherein the switch to communicating via the second bandwidth part is based at least in part on the message indicating for the UE to switch the bandwidth part of the UE.

Aspect 4: The method of Aspect 3, wherein: the message comprises an identifier of the second bandwidth part; and the switch to communicating via the second bandwidth part is based at least in part on the message comprising the identifier of the second bandwidth part.

Aspect 5: The method of Aspect 3, wherein: the message indicates a threshold amount of time associated with the communicating via the second bandwidth part; and the method further comprises: communicating via the second bandwidth part for a duration that is less than or equal to the threshold amount of time; and switching from communicating via the second bandwidth part to communicating via a third bandwidth part after the duration.

Aspect 6: The method of any of Aspects 1-5, further comprising: identifying the second bandwidth part for the UE-initiated bandwidth part switching based at least in part on an expected traffic pattern associated with communications at the UE, wherein the transmission of the request is based at least in part on the identifying.

Aspect 7: The method of Aspect 6, wherein the expected traffic pattern associated with the communications at the UE is based at least in part on an application executed by the UE, an application buffer status at the UE, a timing of expected traffic arriving at the UE, a volume of the expected traffic, or a priority of the expected traffic.

Aspect 8: The method of Aspect 6, further comprising: receiving, from a network node, assistance information associated with the expected traffic pattern, wherein the assistance information comprises one or more quality of service requirements, a downlink buffer size of the network node, or feedback related to a previous UE-initiated bandwidth part switching performed by the UE, and wherein the identifying is based at least in part on the assistance information.

Aspect 9: The method of Aspect 8, wherein identifying the second bandwidth part comprises: executing an AI/ML model, wherein an input to the AI/ML model comprises one or more parameters associated with the expected traffic pattern, the assistance information, or both, and wherein an output of the AI/ML model comprises an indication of the second bandwidth part for the UE-initiated bandwidth part switching.

Aspect 10: The method of Aspect 9, further comprising: receiving, from the network node, an indication of one or more performance indicators associated with the UE-initiated bandwidth part switching to the second bandwidth part, wherein the input to the AI/ML model further comprises the one or more performance indicators.

Aspect 11: The method of any of Aspects 1-10, wherein the request comprises an indication of the second bandwidth part.

Aspect 12: The method of any of Aspects 1-11, wherein the request comprises an indication of a duration associated with communicating via the second bandwidth part, an indication of a periodicity associated with the bandwidth part switching operation, or both.

Aspect 13: The method of any of Aspects 1-12, further comprising: receiving configuration information indicating one or more bandwidth parts, including at least the second bandwidth part, for the UE-initiated bandwidth part switching.

Aspect 14: The method of any of Aspects 1-13, further comprising: communicating via the second bandwidth part for a duration based at least in part on the switch; and switching from communicating via the second bandwidth part to communicating via a third bandwidth part after the duration.

Aspect 15: The method of Aspect 14, wherein: the control signaling indicates a threshold amount of time associated with the UE-initiated bandwidth part switching; and the duration for communicating via the second bandwidth part is less than or equal to the threshold amount of time.

Aspect 16: The method of Aspect 14, further comprising: transmitting, based at least in part on starting an inactivity timer during the duration, signaling indicating the switch from communicating via the second bandwidth part, wherein the switch to communicating via the third bandwidth part is based at least in part on the transmission of the signaling.

Aspect 17: The method of Aspect 16, wherein the signaling comprises an indication of the third bandwidth part.

Aspect 18: The method of any of Aspects 1-17, wherein: the control signaling comprises an indication of a timer value that is associated with an earliest time allowed for the UE-initiated bandwidth part switching; and the method further comprises: setting a timer to the timer value; and transmitting the request after an expiration of the timer.

Aspect 19: The method of any of Aspects 1-18, wherein the control signaling indicates that an earliest time allowed for the UE-initiated bandwidth part switching corresponds to a time at which the UE receives the control signaling based at least in part on a timer value indicated by the control signaling not being set.

Aspect 20: The method of any of Aspects 1-19, wherein the control signaling corresponds to DCI, a MAC-CE, or RRC signaling.

Aspect 21: The method of any of Aspects 1-20, wherein the request comprises UCI, a MAC-CE, or RRC signaling.

Aspect 22: A method of wireless communication performed by a UE, comprising: transmitting, to a network node, signaling indicating one or more parameters associated with an expected traffic pattern of communications at the UE; and receiving, from the network node, a bandwidth part switching command indicating for the UE to switch from communicating via a first bandwidth part to communicating via a second bandwidth part.

Aspect 23: The method of Aspect 22, wherein the one or more parameters associated with the expected traffic pattern comprise one or more applications executed by the UE, an application buffer status at the UE, a timing of expected traffic arriving at the UE, a volume of the expected traffic, or a priority of the expected traffic.

Aspect 24: The method of any of Aspects 22-23, wherein the signaling indicating the one or more parameters associated with the expected traffic pattern corresponds to UCI, a MAC-CE, or RRC signaling.

Aspect 25: The method of any of Aspects 22-24, wherein receiving the bandwidth part switching command comprises receiving DCI, a MAC-CE, or RRC signaling.

Aspect 26: A method of wireless communication performed by a network node, comprising: receiving, from a UE, signaling indicating one or more parameters associated with an expected traffic pattern of communications at the UE; identifying a bandwidth part switch of the UE from communicating via a first bandwidth part to communicating via a second bandwidth part based at least in part on an output of an AI/ML model, wherein the one or more parameters associated with the expected traffic pattern are input to the AI/ML model; and transmitting, to the UE, a bandwidth part switching command indicating for the UE to switch from communicating via the first bandwidth part to communicating via the second bandwidth part.

Aspect 27: The method of Aspect 26, wherein the one or more parameters associated with the expected traffic pattern comprise one or more applications executed by the UE, an application buffer status at the UE, a timing of expected traffic arriving at the UE, a volume of the expected traffic, or a priority of the expected traffic.

Aspect 28: The method of any of Aspects 26-27, wherein the output of the AI/ML model is an indication of the bandwidth part switch of the UE to communicating via the second bandwidth part.

Aspect 29: The method of any of Aspects 26-28, wherein the signaling indicating the one or more parameters associated with the expected traffic pattern corresponds to UCI, a MAC-CE, or RRC signaling.

Aspect 30: The method of any of Aspects 26-29, wherein transmitting the bandwidth part switching command comprises transmitting DCI, a MAC-CE, or RRC signaling.

Aspect 31: A method of wireless communication performed by a network node, comprising: transmitting, to a UE, control signaling indicating that UE-initiated bandwidth part switching is allowed; receiving, from the UE and based at least in part on the UE-initiated bandwidth part switching being allowed, a request to switch a bandwidth part of the UE; and switching from communicating with the UE via a first bandwidth part to communicating via a second bandwidth part based at least in part on the reception of the request to switch the bandwidth part of the UE.

Aspect 32: The method of Aspect 31, wherein the control signaling indicates for the UE to perform the UE-initiated bandwidth part switching autonomously.

Aspect 33: The method of any of Aspects 31-32, further comprising: transmitting, to the UE, a message indicating whether the UE is to switch the bandwidth part of the UE based at least in part on the reception of the request, wherein the switch to communicating via the second bandwidth part is based at least in part on the message indicating for the UE to switch the bandwidth part of the UE.

Aspect 34: The method of Aspect 33, wherein: the message comprises an identifier of the second bandwidth part; and the switch to communicating via the second bandwidth part is based at least in part on the message comprising the identifier of the second bandwidth part.

Aspect 35: The method of Aspect 33, wherein: the message indicates a threshold amount of time associated with the communicating via the second bandwidth part; and the method further comprises: communicating via the second bandwidth part for a duration that is less than or equal to the threshold amount of time; and switching from communicating with the UE via the second bandwidth part to communicating with the UE via a third bandwidth part after the duration.

Aspect 36: The method of any of Aspects 31-35, further comprising: transmitting, to the UE, assistance information associated with an expected traffic pattern associated with communications at the UE, wherein the assistance information comprises one or more quality of service requirements, a downlink buffer size of the network node, or feedback related to a previous UE-initiated bandwidth part switching performed by the UE, and wherein the expected traffic pattern associated with the communications at the UE is based at least in part on an application executed by the UE, an application buffer status at the UE, a timing of expected traffic arriving at the UE, a volume of the expected traffic, or a priority of the expected traffic.

Aspect 37: The method of any of Aspects 31-36, further comprising: transmitting, to the UE, an indication of one or more performance indicators associated with the UE-initiated bandwidth part switching to the second bandwidth part.

Aspect 38: The method of any of Aspects 31-37, wherein the request comprises an indication of the second bandwidth part.

Aspect 39: The method of any of Aspects 31-38, wherein the request comprises an indication of a duration associated with communicating via the second bandwidth part, an indication of a periodicity associated with the bandwidth part switching operation, or both.

Aspect 40: The method of any of Aspects 31-39, further comprising: transmitting configuration information to the UE indicating one or more bandwidth parts, including at least the second bandwidth part, for the UE-initiated bandwidth part switching.

Aspect 41: The method of any of Aspects 31-40, further comprising: communicating with the UE via the second bandwidth part for a duration based at least in part on the switch; and switching from communicating with the UE via the second bandwidth part to communicating with the UE via a third bandwidth part after the duration.

Aspect 42: The method of Aspect 41, wherein: the control signaling indicates a threshold amount of time associated with the UE-initiated bandwidth part switching; and the duration for communicating via the second bandwidth part is less than or equal to the threshold amount of time.

Aspect 43: The method of Aspect 41, further comprising: receiving, from the UE, signaling indicating the switch from communicating via the second bandwidth part, wherein the switch to communicating via the third bandwidth part is based at least in part on the reception of the signaling.

Aspect 44: The method of Aspect 43, wherein the signaling comprises an indication of the third bandwidth part.

Aspect 45: The method of any of Aspects 31-44, wherein: the control signaling comprises an indication of a timer value that is associated with an earliest time allowed for the UE-initiated bandwidth part switching.

Aspect 46: The method of any of Aspects 31-45, wherein the control signaling indicates that an earliest time allowed for the UE-initiated bandwidth part switching corresponds to a time at which the UE receives the control signaling based at least in part on a timer value indicated by the control signaling not being set.

Aspect 47: The method of any of Aspects 31-46, wherein the control signaling corresponds to DCI, a MAC-CE, or RRC signaling.

Aspect 48: The method of any of Aspects 31-47, wherein the request comprises UCI, a MAC-CE, or RRC signaling.

Aspect 49: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-48.

Aspect 50: An apparatus for wireless communication at a device, the apparatus comprising one or more memories and one or more processors coupled to the one or more memories, the one or more processors configured to cause the device to perform the method of one or more of Aspects 1-48.

Aspect 51: An apparatus for wireless communication, the apparatus comprising at least one means for performing the method of one or more of Aspects 1-48.

Aspect 52: A non-transitory computer-readable medium storing code for wireless communication, the code comprising instructions executable by one or more processors to perform the method of one or more of Aspects 1-48.

Aspect 53: A non-transitory computer-readable medium storing a set of instructions for wireless communication, the set of instructions comprising one or more instructions that, when executed by one or more processors of a device, cause the device to perform the method of one or more of Aspects 1-48.

Aspect 54: A device for wireless communication, the device comprising a processing system that includes one or more processors and one or more memories coupled with the one or more processors, the processing system configured to cause the device to perform the method of one or more of Aspects 1-48.

Aspect 55: An apparatus for wireless communication at a device, the apparatus comprising one or more memories and one or more processors coupled to the one or more memories, the one or more processors individually or collectively configured to cause the device to perform the method of one or more of Aspects 1-48.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive control signaling indicating that UE-initiated bandwidth part switching is allowed;
transmit, based at least in part on the UE-initiated bandwidth part switching being allowed, a request to switch a bandwidth part of the UE; and
switch from communicating via a first bandwidth part to communicating via a second bandwidth part based at least in part on the transmission of the request to switch the bandwidth part of the UE.

2. The apparatus of claim 1, wherein the control signaling indicates for the UE to perform the UE-initiated bandwidth part switching autonomously, and wherein the one or more processors are further configured to cause the UE to switch to communicating via the second bandwidth part autonomously based at least in part on the transmission of the request.

3. The apparatus of claim 1, wherein the one or more processors are further configured to cause the UE to:
receive a message indicating whether the UE is to switch the bandwidth part of the UE based at least in part on the transmission of the request, wherein the switch to communicating via the second bandwidth part is based at least in part on the message indicating for the UE to switch the bandwidth part of the UE.

4. The apparatus of claim 3, wherein:
the message comprises an identifier of the second bandwidth part; and
the switch to communicating via the second bandwidth part is based at least in part on the message comprising the identifier of the second bandwidth part.

5. The apparatus of claim 3, wherein the message indicates a threshold amount of time associated with the communicating via the second bandwidth part, and wherein the one or more processors are further configured to cause the UE to:
communicate via the second bandwidth part for a duration that is less than or equal to the threshold amount of time; and
switch from communicating via the second bandwidth part to communicating via a third bandwidth part after the duration.

6. The apparatus of claim 1, wherein the one or more processors are further configured to cause the UE to:
identify the second bandwidth part for the UE-initiated bandwidth part switching based at least in part on an expected traffic pattern associated with communications at the UE, wherein the transmission of the request is based at least in part on the identifying.

7. The apparatus of claim 6, wherein the expected traffic pattern associated with the communications at the UE is based at least in part on an application executed by the UE, an application buffer status at the UE, a timing of expected traffic arriving at the UE, a volume of the expected traffic, or a priority of the expected traffic.

8. The apparatus of claim 6, wherein the one or more processors are further configured to cause the UE to:
receive, from a network node, assistance information associated with the expected traffic pattern,
wherein the assistance information comprises one or more quality of service requirements, a downlink buffer size of the network node, or feedback related to a previous UE-initiated bandwidth part switching performed by the UE, and
wherein the identifying is based at least in part on the assistance information.

9. The apparatus of claim 8, wherein the one or more processors, to cause the UE to identify the second bandwidth part, are further configured to cause the UE to:
execute an artificial intelligence or machine learning model,
wherein an input to the artificial intelligence or machine learning model comprises one or more parameters associated with the expected traffic pattern, the assistance information, or both, and
wherein an output of the artificial intelligence or machine learning model comprises an indication of the second bandwidth part for the UE-initiated bandwidth part switching.

10. The apparatus of claim 9, wherein the one or more processors are further configured to cause the UE to:
receive, from the network node, an indication of one or more performance indicators associated with the UE-initiated bandwidth part switching to the second bandwidth part, wherein the input to the artificial intelligence or machine learning model further comprises the one or more performance indicators.

11. The apparatus of claim 1, wherein the request comprises an indication of the second bandwidth part.

12. The apparatus of claim 1, wherein the request comprises an indication of a duration associated with communicating via the second bandwidth part, an indication of a periodicity associated with the bandwidth part switching operation, or both.

13. The apparatus of claim 1, wherein the one or more processors are further configured to cause the UE to:
receive configuration information indicating one or more bandwidth parts, including at least the second bandwidth part, for the UE-initiated bandwidth part switching.

14. The apparatus of claim 1, wherein the one or more processors are further configured to cause the UE to:
communicate via the second bandwidth part for a duration based at least in part on the switch; and
switch from communicating via the second bandwidth part to communicating via a third bandwidth part after the duration.

15. The apparatus of claim 14, wherein:
the control signaling indicates a threshold amount of time associated with the UE-initiated bandwidth part switching; and
the duration for communicating via the second bandwidth part is less than or equal to the threshold amount of time.

16. The apparatus of claim 14, wherein the one or more processors are further configured to cause the UE to:
transmit, based at least in part on starting an inactivity timer during the duration, signaling indicating the switch from communicating via the second bandwidth part, wherein the switch to communicating via the third bandwidth part is based at least in part on the transmission of the signaling.

17. The apparatus of claim 16, wherein the signaling comprises an indication of the third bandwidth part.

18. The apparatus of claim 1, wherein the control signaling comprises an indication of a timer value that is associated with an earliest time allowed for the UE-initiated bandwidth part switching, and wherein the one or more processors are further configured to cause the UE to:
set a timer to the timer value; and
transmit the request after an expiration of the timer.

19. The apparatus of claim 1, wherein the control signaling indicates that an earliest time allowed for the UE-initiated bandwidth part switching corresponds to a time at which the UE receives the control signaling based at least in part on a timer value indicated by the control signaling not being set.

20. The apparatus of claim 1, wherein the control signaling corresponds to downlink control information, a medium access control control element, or radio resource control signaling.

21. The apparatus of claim 1, wherein the request comprises uplink control information, a medium access control control element, or radio resource control signaling.

22. A method of wireless communication performed by a user equipment (UE), comprising:
receiving control signaling indicating that UE-initiated bandwidth part switching is allowed;
transmitting, based at least in part on the UE-initiated bandwidth part switching being allowed, a request to switch a bandwidth part of the UE; and
switching from communicating via a first bandwidth part to communicating via a second bandwidth part based at least in part on the transmission of the request to switch the bandwidth part of the UE.

23. The method of claim 22, wherein the control signaling indicates for the UE to perform the UE-initiated bandwidth part switching autonomously, and wherein the method further comprises switching to communicating via the second bandwidth part autonomously based at least in part on the transmission of the request.

24. The method of claim 22, further comprising:
receiving a message indicating whether the UE is to switch the bandwidth part of the UE based at least in part on the transmission of the request, wherein the switch to communicating via the second bandwidth part is based at least in part on the message indicating for the UE to switch the bandwidth part of the UE.

25. The method of claim 22, further comprising:
identifying the second bandwidth part for the UE-initiated bandwidth part switching based at least in part on an expected traffic pattern associated with communications at the UE, wherein the transmission of the request is based at least in part on the identifying.

26. The method of claim 25, wherein the expected traffic pattern associated with the communications at the UE is based at least in part on an application executed by the UE, an application buffer status at the UE, a timing of expected traffic arriving at the UE, a volume of the expected traffic, or a priority of the expected traffic.

27. The method of claim 25, further comprising:
receiving, from a network node, assistance information associated with the expected traffic pattern,
wherein the assistance information comprises one or more quality of service requirements, a downlink buffer size of the network node, or feedback related to a previous UE-initiated bandwidth part switching performed by the UE, and
wherein the identifying is based at least in part on the assistance information.

28. The method of claim 27, wherein identifying the second bandwidth part comprises:
executing an artificial intelligence or machine learning model,
wherein an input to the artificial intelligence or machine learning model comprises one or more parameters associated with the expected traffic pattern, the assistance information, or both, and
wherein an output of the artificial intelligence or machine learning model comprises an indication of the second bandwidth part for the UE-initiated bandwidth part switching.

29. A non-transitory computer-readable medium storing a set of instructions for wireless communication, the set of instructions comprising:
one or more instructions that, when executed by one or more processors of a user equipment (UE), cause the UE to:
receive control signaling indicating that UE-initiated bandwidth part switching is allowed;
transmit, based at least in part on the UE-initiated bandwidth part switching being allowed, a request to switch a bandwidth part of the UE; and
switch from communicating via a first bandwidth part to communicating via a second bandwidth part based at least in part on the transmission of the request to switch the bandwidth part of the UE.

30. An apparatus for wireless communication, comprising:
means for receiving control signaling indicating that UE-initiated bandwidth part switching is allowed;
means for transmitting, based at least in part on the UE-initiated bandwidth part switching being allowed, a request to switch a bandwidth part of the apparatus; and
means for switching from communicating via a first bandwidth part to communicating via a second bandwidth part based at least in part on the transmission of the request to switch the bandwidth part of the apparatus.
